(19) United States
(12) Patent Application Publication
(10) Pub. No.: US 2016/0180033 A1
(43) Pub. Date: Jun. 23, 2016

(54) HEALTHCARE FACILITY WORKFLOW MANAGEMENT

(71) Applicant: Opake Inc., New York, NY (US)

(72) Inventor: Matthew S. Rosenberg, New York, NY (US)

(21) Appl. No.: 14/978,107

(22) Filed: Dec. 22, 2015

Related U.S. Application Data
(60) Provisional application No. 62/096,096, filed on Dec. 23, 2014.
(60) Provisional application No. 62/145,830, filed on Apr. 10, 2015.

(51) Int. Cl. G06F 19/00; G06Q 10/08; G06Q 50/22; G06Q 10/06

(52) U.S. Cl. CPC G06F 19/327; G06F 19/328; G06Q 10/06316; G06Q 10/087; G06Q 50/22

(57) ABSTRACT

A method includes generating a preference card providing information associated with a healthcare facility workflow. When executed, the preference card causes a computing device to provide an interface including a timeline illustrating at least one segment of a plurality of sequential segments of the workflow, a list of inventory items associated with the at least one segment, a predetermined quantity of each item of the list of inventory items required for the at least one segment, and a control operable to receive input associated with at least one item of the list of inventory items. The method also includes providing the preference card, via a network, to a computing device, receiving an input indicating a change in information provided by the interface, and generating a bill comprising a total cost determined based at least partly on the input.

### CROSS-REFERNCE TO RELATED APPLICATIONS

This application claims the benefit of U.S. Provisional Application No. 62/096,096, filed Dec. 23, 2014, and U.S. Provisional Application No. 62/145,830, filed Apr. 10, 2015, the entire disclosures of which are incorporated herein by reference.

### BACKGROUND

Managing inventory and other workflow tasks across large and small facilities or organizations can be a difficult task. For example, in many large organizations various inventory items can be stored in a variety of different physical locations within the facility. As a result, maintaining a real-time record of the items in inventory can be nearly impossible. These difficulties are compounded by the large number of different inventory items maintained by such organizations as well as the large number of different users across the organization that remove items from inventory in order to perform various workflow tasks. Additionally, many of the suppliers providing inventory items to such organizations lack standardized labeling protocols, thereby complicating supply chain management.

These issues can be particularly vexing in hospitals, skilled nursing facilities, and/or other healthcare facilities where the time constraints associated with providing healthcare services to patients can be detrimental to effective inventory management. In particular, physicians, nurses, physician's assistants, and other healthcare facility staff members often do not have time to maintain or update inventory records. While inventory systems have been developed to assist such healthcare facility staff members with inventory management, such systems can be cumbersome and time consuming to use. Further, such systems do not provide a nexus between the physician's inventory item preferences, the availability and/or physical location of such inventory items within the healthcare facility, the timeline (e.g., the individual segments of the healthcare facility workflow) at which such items are required for use by the physician or other staff member, and the physical location within the healthcare facility at which the inventory item will be used and/or at which the respective segment of the healthcare facility workflow will be performed.

Further, such systems do not enable the user to easily identify the actual quantity of inventory items used during one or more segments of the workflow, and to generate one or more reports and/or bills based on such information. As a result, inventory reports and/or healthcare facility invoices generated using such systems typically do not accurately reflect the actual quantity of inventory items utilized during the workflow. Also, such reports and/or invoices typically do not capture expenses associated with “non-inventory” items that are used during the workflow, and that are supplied by vendors, representatives, or other third parties.

Example embodiments of the present disclosure are directed toward overcoming one or more of the difficulties described above.

### SUMMARY

This disclosure describes systems and methods associated with managing aspects of healthcare facility workflows. For example, a system of the present disclosure includes one or more processing units, and computer-readable media operably connected to the one or more processing units, the computer-readable media storing a plurality of modules that, when executed by the one or more processing units, cause the one or more processing units to perform operations. Such operations include generating, by a dashboard module, a preference card associated with a healthcare facility workflow. Example preference cards will be described below with respect to FIGS. 1-5D. In any of the examples described herein, when executed, the preference card causes a computing device to provide an interface including a timeline illustrating at least one segment of a plurality of sequential segments of the workflow, an indicator identifying progress in the at least one segment, a list of inventory items associated with the at least one segment, and a control operable to receive input associated with at least one item of the list of inventory items. Such operations may also include receiving, by the control, an input associated with the at least one item, updating, by an inventory module and in real time, a database at least partly in response to receiving the input, and generating, by the inventory module, a report associated with the workflow. Such a report may indicate a predetermined quantity of items associated with the workflow and an actual quantity of items used during the workflow, wherein the actual quantity is based at least partly on the input.

In such examples, the input may comprise a touch input, and the control may comprise at least one of an add button operable to enable an additional item to be added to the list of inventory items and an edit button operable to enable modification of information associated with the at least one item. Additionally, the timeline may include a plurality of milestones, at least one milestone of the plurality of milestones at least partly defining the at least one segment, and the indicator identifying progress in the at least one segment in real time. Further, the list of inventory items may indicate a quantity of each item of the list of inventory items required for the at least one segment, and a real-time location of each item of the list of inventory items. In still further examples, the interface may also include workflow information comprising at least one of a time-sensitive alert, a real-time inventory update, and information associated with a patient receiving services during the workflow. Also, when executed, the communication module performs further operations, comprising providing the preference card, via a network, to a computing device.

In such systems, the operations may also include, by a billing module, generating a bill based at least partly on the report, the bill comprising a total cost determined based on the actual quantity of items included in the report. Further, when executed, at least one of the billing module and the inventory module may perform further operations, comprising incorporating a captured image of a receipt associated with an item identified in the report into at least one of the report and the bill. In such examples, the bill may comprise a text file, a character file, or other electronic file including the name, actual quantity used, type, description and/or information describing one or more inventory items. The bill may also include a per-item cost and/or a total cost of all the inventory items actually used during one or more segments of a healthcare facility workflow. In addition, for purposes of reimbursement and/or description, the billing module and/or the inventory module may merge one or more digital images or other content with the electronic bill file. Such a digital image or other content may be digitally combined with the electronic bill file such that the bill comprises first electronic content (e.g., text, characters, and/or other content describing one or more inventory items) and second electronic content (e.g., one or more digital visual images of a receipt/invoice corresponding to at least one of the inventory items listed on the bill). It is understood that a challenge in healthcare involves reimbursement for services as well as supplies (e.g., inventory items). Due to the improved inventory control processes described herein, all stakeholders know not only the cost, but the revenue and source (e.g. from a patient or an insurance company) with hopefully more clarity and more timeliness. This in turn allows for more cost-conscious product selection, among other benefits.

Additionally, when executed, the communications module may perform further operations, comprising receiving private patient information during a segment of the plurality of segments prior to the at least one segment. In such systems, the operations may further include, by an encryption module, generating an encryption key corresponding to the private patient information, and associating the encryption key with the private patient information such that an electronic transfer of the private patient information includes a corresponding electronic transfer of the encryption key. The operations may also include, a compression module, generating modified information by compressing at least a portion of the private patient information, and storing the modified information within the computer-readable media.

In additional example embodiments of the present disclosure, a method may include generating a first preference card associated with a healthcare facility workflow, wherein when executed, the first preference card causes a computing device to provide a first interface including a timeline illustrating a first segment of a plurality of sequential segments of the workflow, a first list of inventory items associated with the first segment, and a first control operable to receive input associated with at least one item of the first list of inventory items. The method may also include generating a second preference card associated with the workflow different from the first preference card, wherein when executed, the second preference card causes the computing device to provide a second interface including a timeline illustrating a second segment of the plurality of sequential segments adjacent to the first segment, a second list of inventory items associated with the second segment, and a second control operable to receive input associated with at least one item of the second list of inventory items. Such a method may also include receiving an input by at least one of the first control and the second control, and updating a database, in real time, at least partly in response to receiving the input.

In any of the above examples, a method may also include generating an indicator associated with at least one of the timeline illustrating the first segment and the timeline illustrating the second segment, the indicator identifying progress with respect to at least one of the first segment and the second segment, additionally, the second preference card may be generated at least partly in response to completion of the first segment. Further, the input may indicate an actual quantity of an item used during the workflow, and the method may further include generating a bill comprising a total cost determined based at least partly on the actual quantity of the item. The method may also include capturing an image of a receipt and incorporating the image into the bill. Additionally, the first list may indicate a quantity of the at least one item of the first list required for the first segment, and a real-time location of the at least one item of the first list.

In still another example embodiment of the present disclosure, a method may include generating a preference card associated with a healthcare facility workflow, wherein when executed, the preference card causes a computing device to provide an interface including a timeline illustrating at least one segment of a plurality of sequential segments of the workflow, a list of inventory items associated with the at least one segment, a predetermined quantity of each item of the list of inventory items required for the at least one segment, and a control operable to receive input associated with at least one item of the list of inventory items. The method may also include providing the preference card, via a network, to a computing device, receiving an input, via the network, from the computing device, the input indicating a change in information provided by the interface, and updating a database, in real time, at least partly in response to receiving the input from the computing device. The method may also include generating a bill comprising a total cost determined based at least partly on the input.

In such an example method, the input may include at least one of an addition of an item to the list of inventory items, a deletion of an item from the list of inventory items, a modification of workflow information provided by the interface, and an indication of an actual quantity of an item used during the at least one segment. The method may also include receiving, via the network, from the computing device an indication of an actual quantity of an item used during the at least one segment, and generating the bill based at least partly on the actual quantity. Additionally, such a method may include receiving, via the network, an image of a receipt from the computing device, and incorporating the image into the bill, wherein the receipt is associated with an item used during the at least one segment and not in inventory. Also, such a method may include generating at least one of a time-sensitive alert and a real-time inventory update, and providing the at least one of the time-sensitive alert and the real-time inventory update, via the network, to the computing device such that the at least one of the time-sensitive alert and the real-time inventory update is displayed in the interface.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, can refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment including a central administrative service and/or other computing devices usable to implement example healthcare facility workflows described herein.

FIG. 2 is a block diagram depicting an example administrative service computing device usable to implement example healthcare facility workflows described in connection with the environment of FIG. 1.

FIG. 3 is a block diagram depicting an example user computing device usable to implement example healthcare facility workflows described in connection with the environment of FIG. 1.

FIG. 4 is a block diagram depicting an example healthcare facility workflow, and various corresponding preference cards, described herein.

FIG. 5A is a flowchart that illustrates a method associated with an example healthcare facility workflow implemented in the environment shown in FIG. 1.

FIG. 5B is a block diagram associated with the example flowchart of FIG. 5A and illustrating an example preference card displayed by a user computing device.

FIG. 5C is another block diagram associated with the example flowchart of FIG. 5A and illustrating another example preference card displayed by a user computing device.

FIG. 5D is a further block diagram associated with the example flowchart of FIG. 5A and illustrating another example preference card displayed by a user computing device.

FIG. 5E is yet another block diagram associated with the example flowchart of FIG. 5A and illustrating another example preference card displayed by a user computing device.

### DETAILED DESCRIPTION

### Overview

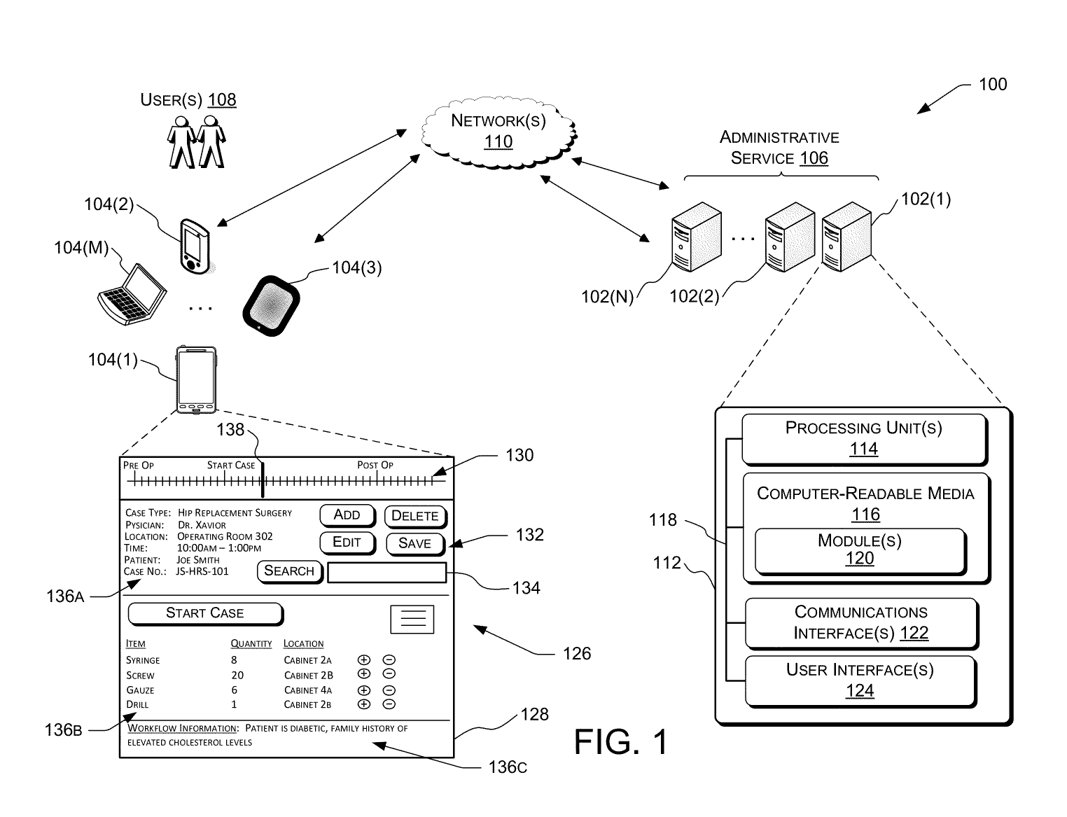

Examples described herein provide environments, systems, and methods associated with various healthcare facility workflows. Various environments, configurations of electronic devices, and methods operating and/or facilitating a healthcare facility workflow are described with reference to FIGS. 1-5E. While many examples described herein relate to servers and other non-consumer electronic devices, other types of electronic devices can be used, e.g., as discussed with reference to FIG. 1.

As will be described in greater detail below, the systems and methods of the present disclosure provide a plurality of sequential preference cards for use in managing a workflow and/or inventory associated with the workflow. The preference cards and workflow described herein are explained, merely for discussion purposes, with reference to healthcare facilities, healthcare facility staff members, and the like. It is understood, however, that these descriptions and explanations are merely examples of one environment in which the methods and systems of the present disclosure may be used, and these descriptions and explanations do not limit the aspects of the present disclosure to such environments in any way.

In some examples, the preference cards described herein provide a unique and convenient nexus between workflow and inventory events occurring in real time, the location at which such events are occurring, the location at which certain inventory items are located, and the preferences of the various users providing services during the workflow. For example, the preference cards may be generated by a central computing device and provided to one or more user computing devices, located remote from the central computing device, in real time, via one or more networks. The preference cards may include lists of inventory items that indicate the particular user's preference (e.g., quantity, brand, type, etc.) associated with the inventory items to be used during different respective segments of the workflow. In this way, the preference cards may be tailored to the particular tastes and preferences of each individual user. Additionally, the preference cards may be configured to receive input from the user regarding a variety of different aspects of the workflow information provided by the preference cards. Such inputs may indicate, for example, modifications, corrections, additions, deletions, notes, or other information provided by the user. Such inputs may be directed to the central computing device by the user computing device, and the central computing device and/or the user computing device may modify the preference card in response to and based at least partly on the input. In particular, each preference card may comprise an executable API or other digital or electronic file. The central computing device and/or the user computing device may modify such digital or electronic files and/or generate a new or revised digital or electronic file based on the input. The preference cards may, for example, comprise an application executable on the user computing device.

Example preference cards of the present disclosure may also enable the user to indicate the actual quantity of items used during different segments of the workflow. Such information may be stored locally at the user computing device and/or at the central computing device. Additionally, such preference cards and/or the central computing device may be configured to generate one or more reports or bills associated with the workflow. Such reports and/or bills may be generated based at least in part on the actual quantity of items used during the various segments of the workflow. Additionally, the preference cards of the present disclosure may enable the user to capture one or more images of receipts and/or other items, and such captured images may be integrated into the reports and/or bills generated by components of the systems described herein. As a result, the systems of the present disclosure may improve the overall efficiency of the workflow, and may maximize the accuracy of inventory management, reporting, and billing procedures associated with the workflow.

### Illustrative Environment

FIG. 1 shows an example environment 100 including an example system configured to operate a healthcare facility workflow, and/or perform one or more of the methods described herein. In the illustrated example, one or more of the various devices and/or components of the environment 100 may comprise a system of the present disclosure, and such devices and/or components of the environment 100 may include computing device(s) 102(1)-102(N) (individually or collectively referred to herein with reference 102), where N is any integer greater than or equal to 1. The example environment 100 may also include computing devices 104(1)-104(M) (individually or collectively referred to herein with reference 104). Although illustrated as, e.g., desktop computers, laptop computers, tablet computers, cellular phones, personal digital assistants, wearable devices (e.g., watches, glasses, etc.), barcode scanners, and the like, the computing devices 102, 104 can include a diverse variety of device categories, classes, or types and are not limited to a particular type of device. In the illustrated example, computing devices 102 can be computing devices in an administrative service 106, such as a central administrative service in a healthcare facility. In some examples, the administrative service 106 may comprise a cluster of computing devices and/or a cloud service. In the illustrated example, computing devices 104 can be clients of the administrative service 106 and can submit supply chain information, product information, billing information, patient information, messages, search queries, and/or other information to the administrative service 106. Likewise, the computing devices 104 can receive such information or content from the administrative service 106. The computing devices 102 in administrative service 106 can, e.g., share resources, balance load, increase performance, or provide fail-over support or redundancy.

In some examples, computing devices e.g., computing devices 102(1) and 102(2), can communicate with one another to participate in or carry out one or more of the operations described herein. For example, two or more of the computing devices 102 may cooperate to perform one or more supply chain management steps or operations within, for example, a hospital, a physician's office, and/or other healthcare facility. Additionally, one or more of the computing devices 102, 104 may be operated by one or more respective users. For example, in a healthcare facility workflow of the present disclosure, one or more of the computing devices 104 may be operated by user(s) 108. In such examples, one or more of the user(s) 108 may comprise a physician, a physician's assistant, a nurse, a healthcare facility administrator, and/or other staff member participating in an example workflow via, for example, one or more network(s) 110. Such healthcare facility workflows will be described in greater detail below.

The various computing devices 102, 104 can communicate with each other or with other computing devices via the network(s) 110. In some examples, computing devices 102, 104 can also communicate with external devices via network(s) 110. For example, network(s) 110 can include public networks such as the Internet, private networks such as an institutional or personal intranet, or combination(s) of private and public networks. Network(s) 110 can also include any type of wired or wireless network, including but not limited to local area networks (LANs), wide area networks (WANs), satellite networks, cable networks, Wi-Fi networks, WiMAX networks, mobile communications networks (e.g., 3G, 4G, and so forth) or any combination thereof. Network(s) 110 can utilize communications protocols, such as, for example, packet-based or datagram-based protocols such as Internet Protocol (IP), Transmission Control Protocol (TCP), User Datagram Protocol (UDP), other types of protocols, or combinations thereof. Moreover, network(s) 110 can also include a number of devices that facilitate network communications or form a hardware infrastructure for the networks, such as switches, routers, gateways, access points, firewalls, base stations, repeaters, backbone devices, and the like.

Different networks have different characteristics, e.g., bandwidth, latency, accessibility (open, announced but secured, or not announced), or coverage area. The type of network 110 used for any given connection between, e.g., a computing device 104 and administrative service 106 can be selected based on these characteristics and on the type of interaction. Additionally, as will be described below, various file creation, modification, compression, encryption, and/or other processes performed by components of the systems described herein may improve the functionality of such networks. In particular, such processes may generate one or more packets, signals, files, and/or other content, such as compressed content and/or encrypted content. Transferring or processing such content may require reduced memory, processor, and/or other system resources. As a result, such content may be transmitted via the network 110 at faster speeds, and using reduced bandwidth. Accordingly, the generation and/or use of such content may result in improved network performance, improved system performance, and/or improved computing device performance. Additionally, content such as encrypted content, may be inherently more secure than unencrypted content, and may be advantageous in various healthcare facility workflows in which the protection of confidential patient information and/or patient privacy is required. For example, HIPPA regulations may require confidentiality of certain patient information, and the encrypted content described herein may satisfy such HIPPA privacy standards. Such encrypted content may be compressed and/or otherwise modified as described herein, thus resulting in any of the network, system, and/or computing device performance improvements described herein.

Details of an example computing device 102(1) are illustrated at inset 112. The details of the example computing device 102(1) can be representative of others of computing devices 102. However, each of the computing devices 102 can include additional or alternative hardware and/or software components. Still referring to the example of FIG. 1, computing device 102(1) can include one or more processing unit(s) 114 operably connected to one or more computer-readable media 116, e.g., memories, such as via a bus 118, which in some instances can include one or more of a system bus, a data bus, an address bus, a Peripheral Component Interconnect (PCI) Express (PCIe) bus, a PCI bus, a Mini-PCI bus, and any variety of local, peripheral, or independent buses, or any combination thereof In some examples, plural processing units 114 can exchange data through an internal interface bus (e.g., PCIe), rather than or in addition to network 110. While the processing units 114 are described as residing on the computing device 102(1), in this example, the processing units 114 can also reside on different computing devices 102, 104 in some examples. In some examples, at least two of the processing units 114 can reside on different computing devices 102, 104. In such examples, multiple processing units 114 on the same computing device 102, 104 can use a bus 118 of the computing device 102, 104 to exchange data, while processing units 114 on different computing devices 102, 104 can exchange data via network(s) 110.

Computer-readable media described herein, e.g., computer-readable media 116, include computer storage media and/or communication media. Computer storage media includes tangible storage units such as volatile memory, nonvolatile memory, and/or other persistent and/or auxiliary computer storage media, removable and non-removable computer storage media implemented in any method or technology for storage of information such as computer-readable instructions, data structures, program modules, or other data. Computer storage media includes tangible or physical forms of media included in a device or hardware component that is part of a device or external to a device, including but not limited to RAM, static RAM (SRAM), dynamic RAM (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or memories, storage, devices, and/or storage media that can be used to store and maintain information for access by a computing device 102, 104. In contrast to computer storage media, communication media embodies computer-readable instructions, data structures, program modules, or other data in a modulated data signal, such as a carrier wave, or other transmission mechanism. As defined herein, computer storage media does not include communication media. In some examples, computer-readable media 116 can store instructions executable by the processing unit(s) 114, and the processing units 114 can be internal or external (e.g., virtual processing unit) to the computing device 102.

Computer-readable media 116 can store, for example, computer-executable instructions, an operating system, and/or other computer program instructions. The computer-readable media 116 can also store one or more module(s) 120 associated with a healthcare facility workflow of the present disclosure. Such modules 120 may include, for example, a communication module, an encryption module, an inventory module, a billing module, a compression module, and/or any other modules, programs, or applications that are loadable and executable by processing unit(s) 114.

Processing unit(s) 114 can be or include one or more single-core processors, multi-core processors, CPUs, GPUs, GPGPUs, or hardware logic components configured, e.g., via specialized programming from modules or APIs, to perform functions described herein. For example, and without limitation, illustrative types of hardware logic components that can be used in or as processing units 114 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Digital Signal Processors (DSPs), and other types of customizable processors. For example, a processing unit 114 can be a hybrid device, such as a device from ALTERA or XILINX that includes a CPU core embedded in an FPGA fabric. These or other hardware logic components can operate independently or, in some instances, can be driven by a CPU. In some examples, at least some of computing device(s) 102, 104 can include a plurality of processing units 114 of multiple types. For example, the processing units 114 in computing device 102(3) can be a combination of one or more GPGPUs and one or more FPGAs. Different processing units 114 can have different execution models, e.g., as is the case for graphics processing units (GPUs) and central processing unit (CPUs).

The computing device(s) 102, 104 may also include one or more communications interface(s) 122. The communications interface(s) 122 may be connected via the bus 118 to processing units 114 to enable wired or wireless communications between computing device(s) 102 and other networked computing devices 102, 104 over network(s) 110. Such communications interface(s) 122 can include one or more transceiver devices, e.g., network interface controllers (NICs) such as Ethernet NICs or other types of transceiver devices, to send and receive communications over a network. The processing units 114 can exchange data through respective communications interface(s) 122. In some examples, the communications interface 122 can be a PCI Express (PCIe) transceiver, and the network 110 can be a PCIe bus. In some examples, the communications interface 122 can include, but is not limited to, a transceiver for cellular (3G, 4G, or other), WI-FI, Ultra-wideband (UWB), BLUETOOTH, or satellite transmissions. The communications interface 122 can include a wired I/O interface, such as an Ethernet interface, a serial interface, a Universal Serial Bus (USB) interface, an INFINIBAND interface, or other wired interfaces. For simplicity, these and other components are omitted from the illustrated computing device 102(1).

In some examples, computing device 102 can also include one or more user interface(s) 124 configured to permit a user, e.g., a data analyst or neural-network administrator, to operate one or more of the modules 120 and/or other components of the computing device 102 before, during, and/or after, for example, a healthcare facility workflow of the present disclosure. In an example embodiment, a user interface 124 can include one or more output devices configured for communication to a user or to another computing device 102, 104. Output devices can be integral or peripheral to a computing device 102, 104. Examples of output devices can include a display, a printer, audio speakers, beepers, or other audio output devices, a vibration motor, linear vibrator, or other haptic output device, and the like. For example, the user interface 124 can include a display, such as an organic light-emitting-diode (OLED) display, a liquid-crystal display (LCD), a cathode-ray tube (CRT), or another type of visual display. Such a display can be a component of a touchscreen, or can include a touchscreen. User interface 124 can also include one or more input devices, integral or peripheral to a computing device 102, 104. The input devices can be user-operable, or can be configured for input from other computing device 102, 104. Examples of input devices can include, e.g., a keyboard, keypad, a mouse, a trackball, a pen sensor or smart pen, a light pen or light gun, a game controller such as a joystick or game pad, a voice input device such as a microphone, voice-recognition device, or speech-recognition device, a touch input device such as a touchscreen, a gestural or motion input device such as a depth camera, a grip sensor, an accelerometer, another haptic input, a visual input device such as one or more cameras or image sensors, and the like. For example, as part of an example workflow of the present disclosure one or more cameras or other image sensors may be employed to capture an image (e.g., a digital image) of an invoice or other item. The computing device 102, 104 may save such an image in the computer-readable media 116, and one or more of the modules 120 may combine and/or otherwise incorporate the image into a report, a bill, or other electronic file generated during the workflow. In this way, such a report, bill, or other electronic file may be augmented with digital content, such as a digital image, captured by the cameras or other image sensors.

Although not illustrated in FIG. 1, it is understood that any of the example computing device 104(1) described herein may include components that are similar to and/or the same as those described herein with respect to computing device(s) 102. Example computing device(s) 104 can also include additional or alternative hardware and/or software components. For example, although not illustrated in FIG. 1, an example computing device 104 can include one or more processing unit(s) operably connected to one or more computer-readable media, e.g., via a bus. The processing unit(s) of the computing device 104 can be the same as or similar to the example processing units 114 discussed above. Additionally, the computer-readable media and bus of the computing device 104 can be the same as or similar to the example computer-readable media 116 and bus 118 described above. For instance, the computer-readable media of the computing device 104 may store, for example, computer-executable instructions, an operating system, other computer program instructions, and/or one or more modules, programs, or applications that are loadable and executable by processing unit(s) of the computing device 104. As will be described below, the modules of the computing device 104 can include modules that are the same as modules 120 and/or that are different from the modules 120. Computing device 104 can also include one or more communications interfaces connected via the bus to processing unit(s) to enable wired or wireless communications between computing device(s) 104 and other networked computing devices 102 or 104 involved in one or more healthcare facility workflows or other computing functions over network(s) 110. Computing device 104 can also include a user interface connected via the bus to processing unit(s). The communications interfaces of the computing device 104 may be the same as or similar to the communications interface(s) 122 described above, and the user interface of the computing device 104 may be the same as or similar to the user interface(s) 124.

Any of the computing devices 102, 104 described herein may be configured to provide one or more dashboards 126 or other user interfaces such as, via a display or other user interface 124 of the computing device. As illustrated with respect to the computing device 104(1) of FIG. 1, an example dashboard 126 may provide a variety of information and functionality to a user 108 including, among other things, one or more preference cards 128 associated with aspects of a healthcare facility workflow. In any of the examples described herein, a preference card 128 may comprise one or more executable API's, routines, programs, protocols, and/or or other digital or electronic files. For example, the preference card 128 may be an executable program, application, text file, spreadsheet, or other like electronic file that is transferred from the computing device 102 to the computing device 104, and that is executed by the one or more processing units of the computing device 104 to provide functionality and/or information to the user 108. In some examples, one or more of the preference cards 128 described herein may comprise a database and/or a selection from various databases that allows for the recording and/or capture of product usage information, task lists (e.g., checklist), free form text, characters, and/or other information. For example, preference cards 128 may enable the recording and/or capture of workflow information 136 including, among other things, a physician name, a location of an inventory item, a location of a procedure being performed, a type of procedure being performed, one or more segments of the healthcare facility workflow, and/or other such information. As will be described below, a preference card 128 may include one or more controls and/or other like components/fields configured to receive input (e.g., touch input via a touchscreen of the computing device executing the preference card 128). In such examples, the one or more controls may receive a gesture input (swipe, tap, tap-and-hold, etc.), a touch input, and/or other input, and the performance card 128 may take one or more actions in response to such input. For example, one or more such inputs may be received by a control of the preference card 128 to indicate completion of one or more workflow procedures/tasks, to acknowledge one or more inventory items listed by the user interface corresponding to the preference card 128 has actually been used during a workflow segment, etc. In response to such input, the preference card 128 may control one or more components of the computing device 102, 104 to provide an update to, and/or to update a databases stored in the computer-readable media described herein. Additionally, such updates may cause the computing device 102, 104 to generate one or more real-time alerts, such as a low inventory level alert. The central computing device 102 and/or the user computing device 104 may modify such digital or electronic files during the course of various example workflows in response to input received from the user 108, via components of the preference card 128 and/or via components of the computing device 104. Additionally, the central computing device 102 and/or the user computing device 104 may generate a new or revised digital or electronic file (e.g., a new preference card 128) based on the input.

In some examples, a preference card 128 may include various components and/or may provide various functionality to the user 108. For example, a preference card 128 may include, among other things, a timeline 130 enabling the user 108 to view the entire workflow, or at least one or more segments thereof, in real time. The timeline 130 may also enable the user 108 to view the patient/physician's progress during the workflow (e.g., progress in at least one segment of the workflow), in real time. For example, such progress may be identified by an indicator (discussed below) of the timeline that moves along the timeline in real time and/or based on the actual real-time progress of the patient/physician. Such an indictor may, for example, illustrate the physician's actual progress in multiple sequential segments of the workflow. Such an indicator may also indicate the real-time location and/or status of the patient receiving services during the various segments of the workflow.

The preference card 128 may also include one or more controls 132 enabling the user 108 to add, delete, save, edit, and/or otherwise interact with information provided by the preference card 128. Such controls 132 may, for example, enable the user 108 to update one or more inventory databases, preference card databases, or other databases stored in the computer-readable media 116 of the computing device 102 and/or within computer-readable media of the computing device 104. In example embodiments, one or more of the controls 132 may be configured to receive an input from the user 108 of the computing device 102, 104 via any of the user interfaces 124 described herein. In examples in which the preference card 128 is displayed via a display of the computing device 102, 104, such as a touchscreen display, one or more of the controls 132 may be configured to receive a touch input via the touchscreen. For example, controls 132 of the present disclosure may include, among other things, an add button operable to enable an additional item to be added to a list of inventory items included in the preference card 128, an edit button operable to enable modification of information associated with an item included in the preference card 128, a delete button operable to enable removal of an item from the preference card, a save button operable to enable the preference card 128, and/or changes thereto, to be saved in one or more databases of the computing device 102, 104, and/or any other controls.

The preference card 128 may also include a search control 134 enabling the user 108 to search for information regarding an item and/or inventory associated with a healthcare facility workflow, a physician, physician's assistant, nurse, healthcare facility administrator, and/or other staff member participating in an example workflow, a patient associated with the workflow, a bill associated with the workflow, medical records associated with a particular patient, and/or other content. Such content may be referred to collectively herein as “workflow information 136,” and such workflow information 136 may also be provided by the preference card 128. For example, as identified by item 136A of FIG. 1, such workflow information 136 may include the case type, the case number of the particular case, the physician to whom the particular case has been assigned, the physical location (e.g., room number, floor, etc.) within a healthcare facility at which the segment of the workflow identified by an indicator 138 of the preference card 128 is being performed, the time at which the segment of the workflow identified by the indicator 138 is being performed, the patient's name, and/or other workflow information. In addition, such workflow information 136A may include a medical record number (MRN) and/or an account number. In some examples, a MRN may be a number unique to a patient (similar to a social security number) with respect to a particular healthcare facility/physician. In such examples, regardless of the number of times a particular patient sees a physician and/or has a surgery, the MRN assigned to the patient does not change. Accordingly, in some examples, the MRN may comprise and/or may be used as a unique patient ID. In such examples, however, a new account number may be generated by one or more components of the system 100 each time the physician visits the healthcare facility and/or has a new procedure performed. Such an account number may be used as a reference number indicative of at least one of the patient, the physician, the procedure performed, the healthcare facility at which the procedure was performed, the location within the healthcare facility at which the procedure was performed, the time and/or date at which the procedure was performed, etc. In any of the examples described herein, at least one of the MRN and the account number may be tied to and/or otherwise associated with the one or more inventory items used during a corresponding healthcare facility workflow.

As identified by item 136B of FIG. 1, such workflow information 136 may also include a list of inventory items associated with the segment of the workflow identified by the indicator 138, the quantity of each item in the list of inventory items required to perform the particular/current segment of the workflow, the physical real-time location of each item of the list of inventory items, and/or other information. Further, as identified by item 136C of FIG. 1, such workflow information 136 may also include any other information useful in completing the present segment of the workflow, such as information (private or not private) associated with the patient receiving services during the workflow, patient medical history information, physician notes, a time-sensitive alert, a real-time inventory update, and/or any other information associated with the workflow, inventory, the patient, the physician, and/or the healthcare facility.

An example preference card 128 may also include one or more additional controls enabling the user 108 to, for example, select an item needed for a healthcare facility workflow, enter a quantity of the item needed/used for the workflow, search for the item in an inventory associated with the healthcare facility, update the inventory in real time, create, review, update, and/or modify a preference card associated with a healthcare facility workflow, generate a report associated with the workflow, capture an image of an invoice and/or other item associated with the workflow, indicate completion of the present segment of the workflow, request a new and/or updated preference card from the central computing device 102, and/or perform any other tasks associated with the workflow. Additionally, such preference cards 128 may be provided to, and may be tailored to the particular preferences of, a physician, physician's assistant, nurse, healthcare facility administrator, and/or other staff member participating in an example workflow. Various example preference cards 128 will be described in greater detail below with respect to example healthcare facility workflows.

### Illustrative Components

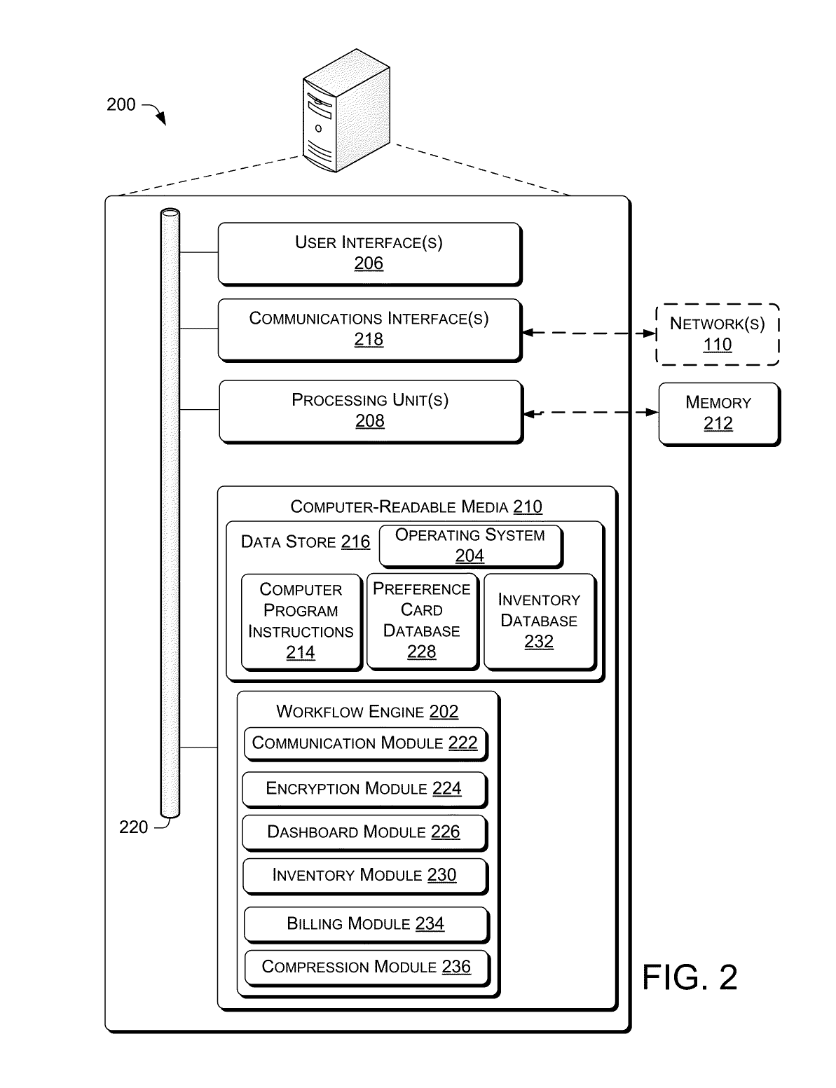

FIG. 2 is an illustrative diagram that shows example components of administrative service computing device 200, which can be similar to or the same as one or more of computing device(s) 102, 104 and which can be a central server or other computing device configured to operate and/or otherwise facilitate a healthcare facility workflow. For example, an administrative service computing device 200 can implement a healthcare facility workflow engine 202, an operating system 204, and/or any other software or hardware component configured to operate such a healthcare facility workflow.

Administrative service computing device 200 can include or be connected to a user interface 206, which can be similar to or the same as the user interface 124 described above with respect to FIG. 1. The user interface 206 can include various types of output devices and/or input devices described above with reference to user interface 124. The user interface 206 can also include one or more input/output (I/O) interfaces to allow the computing device 200 to communicate with input, output, or I/O devices. Examples of such devices can include components of user interface 206 such as user-operable input devices and output devices described above with reference to user interface 124.

The administrative service computing device 200 can include one or more processing unit(s) 208, which can be similar to or the same as processing unit(s) 114 described above with respect to FIG. 1. Processing units 208 can be operably coupled to the I/O interface and/or other user interface(s) 206, as well as to at least one computer-readable media 210. Processing unit(s) 208 can include, e.g., processing unit types described above such as CPU- or GPGPU-type processing unit(s). In some examples, processing unit(s) 208 can include or be connected to a memory 212, e.g., a RAM or cache.

In some examples, computer-readable media 210 of the healthcare facility workflow service computing device 200 can be similar to or the same as computer-readable media 116 described above with respect to FIG. 1, and can store a plurality of modules of the healthcare facility workflow engine 202. The computer-readable media 210 can also store the operating system 204, as well as other items that will be described below. Processing unit(s) 208 can be configured to execute modules of the plurality of modules of the healthcare facility workflow engine 202. For example, computer-executable instructions and/or other computer program instructions 214 stored within a data store 216 of the computer-readable media 210 can, upon execution, configure a computer such as an administrative service computing device 200 to perform operations described herein with reference to the modules of the plurality of modules. The modules stored in the computer-readable media 210 can include instructions that, when executed by the one or more processing units 208, cause the one or more processing units 208 to perform operations described below.

In some examples, data store 216 can include data storage, structured or unstructured, such as a database (e.g., a Structured Query Language, SQL, or NoSQL database) or data warehouse. In some examples, data store 216 can include a corpus or a relational database with one or more tables, arrays, indices, stored procedures, and so forth to enable data access. Data store 216 can store data for the operations of processes, applications, components, or modules stored in computer-readable media 210 or computer instructions in those modules executed by processing unit(s) 208. In some examples, the computer program instructions 214 stored in the data store 216 may comprise instructions corresponding to processes described herein or to other software executable by processing unit(s) 208.

In some examples, the operating system 204 can include components that enable or direct the healthcare facility workflow service computing device 200 to receive data via various inputs (e.g., user controls, network or communications interfaces, memory devices, or sensors), and process the data using the processing unit(s) 208 to generate output. The operating system 204 can further include one or more components that present the output (e.g., display an image on an electronic display, store data in memory, and/or transmit data to another computing device).

The administrative service computing device 200 can also include a communications interface 218, which can be similar to or the same as communications interface 132 described above with respect to FIG. 1. For example, communications interface 218 can include a transceiver device such as a network interface controller (NIC) to send and receive communications over a network 110 (shown in phantom), e.g., as discussed above. As such, the healthcare facility workflow service computing device 200 can have network capabilities. For example, the healthcare facility workflow service computing device 200 can exchange data with computing devices 102, 104 (e.g., laptops, computers, and/or servers) via one or more network(s) 110, such as the Internet.

In some examples, the processing unit(s) 208 can access the module(s) on the computer-readable media 210 via a bus 220, which can be similar to or the same as bus 118 described above with respect to FIG. 1. User interface 206 and communications interface 218 can also communicate with processing unit(s) 208 via bus 220. The modules of the healthcare facility workflow engine 202 stored on computer-readable media 210 can include one or more modules (e.g., shell modules, or API modules) which are illustrated as a communication module 222, an encryption module 224, and a dashboard module 226. In example embodiments, the dashboard module 226 may be in communication with a preference card database 228 of the data store 216, and the preference card database 228 may store individual preference cards 128 that are generated and/or modified by the dashboard module 226. The modules may also include an inventory module 230, and the inventory module 230 may be in communication with an inventory database 232 of the data store 216. As will be described herein, input received via one or more of the preference cards 128 associated with items of an inventory of a healthcare facility may be received by one or more of the communication module 222, the dashboard module 226, and the inventory module 230, and the inventory module 230 may update and/or otherwise modify one or more inventory listings and/or other inventory information stored in the inventory database 232 based at least partly on the input. As shown in FIG. 2, modules of the workflow engine 202 may also include a billing module 234 and a compression module 236.

In the workflow engine 202, the number of modules can vary higher or lower, and modules of various types can be used in various combinations. For example, functionality described associated with the illustrated modules can be combined to be performed by a fewer number of modules or APIs or can be split and performed by a larger number of modules or APIs. For example, the communication module 222 and the encryption module 224 can be combined in a single module that performs at least some of the example functions described below of those modules. Additionally or alternatively, the dashboard module 226, inventory module 230, and/or the billing module 234 can be combined in a single module that performs at least some of the example functions described below of those modules. Further, the compression module 236 and the encryption module 224 can be combined in a single module that performs at least some of the example functions described below of those modules. In some examples, computer-readable media 210 may have thereon computer-executable instructions, the computer-executable instructions, upon execution, configuring a computer to perform operations described herein.

Example functionality associated with the modules of the workflow engine 202 will be described in greater detail below with respect to example healthcare facility workflows. However, in some example systems of the present disclosure, the communication module 222 may be configured to receive inputs, signals, messages, files, data, images, content, and/or other information from one or more of the computing devices 104 described above. Such information may be received, for example, using the communications interface 218 and via the network 110. In such examples, the information received from a user 108 of the computing device 104 may include, among other things, any of the workflow information 136 described herein.

The encryption module 224 may be configured to perform a variety of encryption, decryption, file conversion, file modification, and/or other functions associated with one or more example healthcare facility workflows of the present disclosure. For example, the encryption module 224 may be configured to encrypt the various information, messages, requests, inventory updates, and/or other workflow information 136 received by the communication module 222 as electronic content before, during, and/or after a healthcare facility workflow. For example, such workflow information 136 may be received by the communication interface 218 and/or the communication module 222 in the form of signals, files, and/or packets, and such workflow information 136 may include an encryption key or other encoded information identifying, for example, the sender of the workflow information 136. Additionally or alternatively, such an encryption key may identify a patient with whom the workflow information is associated. In such examples, at least some of the workflow information 136 may be private and/or confidential patient information (e.g., medical records, etc.). The communication module 222 and/or the encryption module 224 may receive such workflow information 136 as an input. For example, the communication module 222 and/or the encryption module 224 may receive such private patient information during an initial segment (e.g., a registration, onboarding, and/or other like initiation segment) of a healthcare facility workflow, and/or prior to, for example, pre-op, operation, post-op, reporting, billing, and/or other segments of the workflow. The encryption module 224 may decrypt such received electronic content in order to authenticate the encryption key. The encryption module 224 may also authenticate the encryption key using one or more accepted receiver lists, patient lists, or other like information stored within the computer-readable media 210. The encryption module 224 may also verify the identity of the sender, the patient, and/or the intended recipient associated with such workflow information 136 based at least partly on matching and/or otherwise authenticating the encryption key using the information stored within the computer readable media 210. In any of the example embodiments described herein, the encryption module 224 may perform any digital signature scheme or other cryptographic authentication scheme. Such encryption and/or decryption processes performed by the encryption module 224 may ensure the privacy of, for example, patient information, medical records, and/or other such regulated workflow information 136.

In still further examples, the encryption module 224 may be configured to encrypt such workflow information 136 prior to transmitting such content using the communication interface 218 and via the network 110. For example, the encryption module 224 may be configured to generate one or more encryption keys, and to embed and/or otherwise incorporate such encryption keys within the workflow information 136 prior to transmitting such content via the network 110. Accordingly, the workflow information 136 and/or other electronic content described herein may be augmented, and/or otherwise altered by the encryption module 224 prior to being transmitted. For example, HIPPA regulations may require confidentiality of certain patient information, and the workflow information 136 and/or other content that is encrypted and/or otherwise altered by the encryption module 224 may satisfy such HIPPA privacy standards. As part of such an encryption process, and/or as a separate process associated with one or more of the example healthcare facility workflows described herein, the encryption module 224 and/or the compression module 236 may modify the various signals, files, packets, images, content, information, messages, requests, inventory updates, and/or other workflow information 136 prior to transmitting such content using the communication interface, 218 and via the network 110. For example, the compression module 236 may compress, zip, and/or otherwise modify workflow information 136, generated at least in part by the encryption module 224, thereby generating modified workflow information prior to transmission. Relative to the original workflow information 136, such modified workflow information may have a reduced size, reduced bandwidth requirements, reduced memory requirement, and/or other such reduced characteristic. As a result, such modified workflow information may be transmitted via the network 110 more quickly, may reduce the bandwidth and/or other system resources required for transmission, and/or may reduce the memory requirements of one or more of the computing devices 200, 102, 104 associated with storing such content. As a result, generation and utilization of such modified workflow information by the encryption module 224 and/or by the compression module 236 may improve the efficiency of the system, components thereof, the network 110, and/or of the healthcare facility workflow facilitated by the system.

As noted above, the dashboard module 226 may be configured to generate and/or modify one or more preference cards 128 of the present disclosure. For example, the dashboard module 226 may be configured to receive information associated with a patient receiving services as part of a healthcare facility workflow, and/or preferences or other such information associated with one or more physicians performing services during one or more segments of the workflow. The dashboard module 226 may incorporate such information into one or more preference cards, preference card formats, templates, or other electronic files stored in, for example, the preference card database 228. In this way, dashboard module 226 may generate one or more preference cards 128 that are particular to and/or otherwise tailored to a particular physician performing a particular service at a healthcare facility. Additionally, such preference cards 128 may incorporate patient information, such as patient preferences, into the preference cards 128 that are generated thereby. During the process of generating one or more such preference cards 128, the dashboard module 226 may, for example, receive information that is scanned, typed, and/or otherwise input into the computer-readable media 210 via, for example, user interfaces 206, and/or other components of the computing device 200. In any of the examples described herein, the communication module 222 may be configured to transfer and/or otherwise provide one or more of the preference cards 128 generated by the dashboard module 226, via the network 110, to one or more computing devices 104.

Additionally, once one or more such preference cards 128 have been generated by the dashboard module 226 and saved in the preference card database 228, the dashboard module 226 may be operable to facilitate modifications, updates, and/or other changes to any of the preference cards 128 stored within the preference card database 228. For example, input received via one or more controls 132 of a particular preference card 128 may be directed to the dashboard module 226, and the dashboard module 226 may update, modify, and/or otherwise change the particular preference card 128, and/or one or more additional corresponding preference cards 128 stored in the preference card database 228. The dashboard module 226 may also provide information associated with the input to, for example, the inventory module 230. For example, in embodiments in which the input is indicative of a quantity, type, location, and/or other attribute of an inventory item used during a particular healthcare facility workflow, the dashboard module 226 may provide information indicative of such an attribute to the inventory module 230. In such examples, inventory module 230 may, for example, make a corresponding change to an inventory list, database, and/or other information stored within the inventory database, 232.

The inventory module 230 may be configured to generate, update, modify, change, and/or output information associated with an inventory of one or more healthcare facilities. Additionally, the inventory module 230 may provide such information to the inventory database 232 for storage therein. For example, the inventory module 230 may be configured to receive information indicative of a list of items that are presently in inventory in a healthcare facility. The inventory module 230 may generate one or more lists of inventory items based at least partly on such information.

Additionally, the inventory module 230 may separate, categorize, and/or otherwise organize such information, and/or the corresponding lists of inventory items based at least partly on inventory items that are required for one or more segments of a healthcare facility workflow. For example, the inventory module 230 may generate one or more lists of inventory items associated with a respective segment of the workflow. In such examples, the list of inventory items may include one or more items (e.g., a scalpel, gloves, fluids, gauze, sutures, hypodermic needles, etc.) required for the respective segment of the workflow. In such examples, the one or more lists of inventory items may be generated based at least partly on preferences of the physician and/or other healthcare facility staff performing one or more tasks associated with the respective segment of the workflow. Any such lists of inventory items may be stored by the inventory module 230 in the inventory database 232.

Additionally, the inventory module 230 may be configured to update, modify, and/or otherwise change one or more lists of inventory items stored within the inventory database 232. For example, during one or more of the healthcare facility workflows described herein, the inventory module 230 may receive information, such as an input, via one or more of the dashboards 126 and/or controls 132. Such information may be indicative of, for example, usage of one or more inventory items in an ongoing healthcare facility workflow. At least partly in response to receiving such information, the inventory module 230 may update the inventory database 232 in real time. In particular, at least partly in response to receiving such information, the inventory module 230 may update, modify, and/or otherwise change name, brand, type, quantity, location, and/or other information included in the list of inventory items stored in the inventory database 232 and associated with one or more inventory items.

In still further examples, the inventory module 230 may be configured to generate one or more reports associated with a healthcare facility workflow. For example, during a reporting segment of the workflow, the inventory module 230 may generate a report indicating a variety of information associated with the various segments of the workflow. Such a report may indicate a predetermined quantity of items associated with the workflow. For instance, as described above, the various preference cards 128 described herein may each indicate a quantity of items to be used during a respective segment of the workflow based at least partly on physician preferences, patient preferences, and/or other factors associated with the particular segment of the workflow. In such examples, a report generated by the inventory module 230 may include information indicative of the name, brand, and/or type of each particular inventory item utilized during the workflow. Additionally, such a report may indicate the preselected or predetermined quantity of each particular inventory item expected to be used during the workflow in accordance with the preference cards 128 associated with the workflow. It is understood that such a report may include, for example, the total number of each inventory item expected to be used by, for example, the physician and/or other healthcare facility staff during the totality of the workflow. For example, a healthcare facility workflow may have three respective segments, and in each segment, two pairs of gloves may be used. In such an example, a report generated by the inventory module 230 corresponding to such a workflow may indicate a total predetermined quantity of gloves equal to six pairs (e.g., 12 gloves total). Such an example report may also indicate a particular brand and/or type of gloves based on a preference of the physician performing various services during the three segments of the workflow. Additionally, such a report may include an actual quantity of inventory items used during the workflow, and such an actual quantity may be based at least partly on one or more inputs received via the one or more preference cards 128 and/or controls 132 during the workflow. For example, one or more inputs received during the workflow may indicate that two pairs of gloves were used during the first and second segments of the workflow, and that three pairs of gloves were used during the third segment of the workflow. In such an example, a report generated by the inventory module 230 corresponding to such a workflow may indicate a total actual quantity of gloves equal to seven pairs (e.g., 14 gloves total).

The billing module 234 may be configured to generate one or more invoices or other such bills based at least partly on input received during a healthcare facility workflow. For example, in embodiments in which one or more of the reports described herein are generated by the inventory module 230, the billing module 234 may generate one or more invoices or other such bills based at least partly on the report. Alternatively, in additional embodiments the billing module 234 may generate one or more invoices or other such bills based at least partly on one or more inputs received via the one or more preference cards 128 and/or controls 132 during the workflow, wherein such inputs are indicative of, for example, an actual quantity of inventory items utilized during the workflow.

In any of the examples described herein, the bill generated by the billing module 234 may include a total cost determined based on the actual quantity of items used during the workflow. For example, in generating the bill, the billing module 234 may multiply the cost of each item by the actual quantity of items used in order to arrive at a per-item total cost. The billing module 234 may then determine a sum of the per-item total costs, and the determined sum may comprise the total cost. The billing module 234 may also incorporate any state, local, federal, and/or other taxes, additional healthcare facility fees, physician's fees, insurance fees, copayments, premiums, and/or other costs associated with the particular healthcare facility workflow, and/or segments thereof, into the total cost represented on the bill. In still further examples, the billing module 234 may compile any of the above costs, and may output such information to one or more additional billing components of the environment 100 described above with respect to FIG. 1 such that a corresponding bill may be generated.

In additional examples, at least one of the billing module 234 and the inventory module 230 may incorporate an image of an invoice, a receipt, and/or other item or document into at least one of the report generated by the inventory module 230, and/or the bill generated by the billing module 234. For example, as described above, one or more cameras or other image sensors of may be employed to capture an image (e.g., a digital image) of an invoice or other item. Such image sensors may store the captured image in, for example, the computer-readable media 210, and at least one of the billing module 234 and the inventory module 230 may combine and/or otherwise incorporate the image into a report, a bill, or other electronic file generated during the workflow. In this way, such a report, bill, or other electronic file may be augmented with digital content, such as a digital image, captured by the cameras or other image sensors.

The billing module 234 may, in some examples, comprise any application, component, system, or component within a system, configured to facilitate payments between parties involved in a healthcare facility workflow. For example, the billing module 234 may be operable to outsource payment interactions between the patient, the patient's insurance provider, and/or the healthcare facility. In such examples, the billing module 234 may connect, for example, a bank account of an insurance provider with a bank account of a healthcare facility in order to facilitate the transfer of funds between the bank accounts. In other examples, the billing module 234 may connect the computing device 200 to an external payment service or other payment platform used by the patient, the patient's insurance provider, and/or the healthcare facility to facilitate payments.

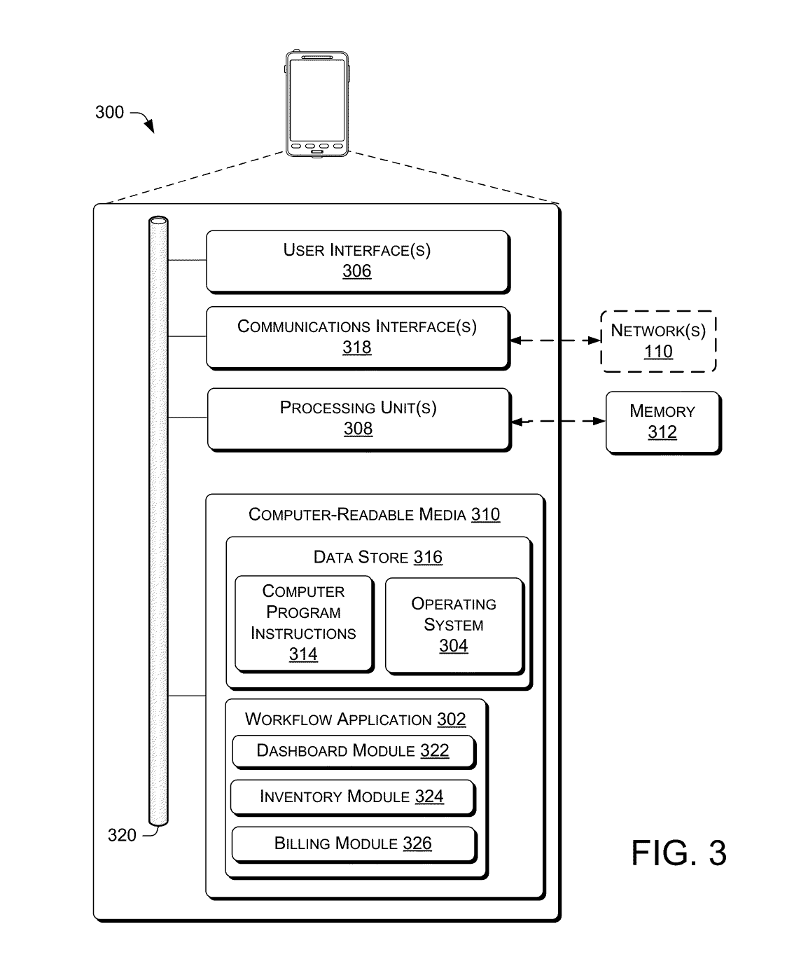

FIG. 3 is an illustrative diagram that shows example components of a user computing device 300, which can be similar to or the same as one or more of computing device(s) 102, 104, and which can be a computing device of a user 108. In particular, the user computing device 300 of FIG. 3 may comprise a computing device 104 of a physician, a physician's assistant, a nurse, a healthcare facility administrator, and/or other healthcare facility staff member participating in an example workflow via, for example, the network 110. In such examples, the user computing device 300 may be used in a centralized healthcare facility workflow in which one or more additional computing devices 200 (FIG. 2) comprises, for example, a central server operating and/or otherwise facilitating the healthcare facility workflow between and/or among two or more users 108. In particular, the environment 100 of FIG. 1 may be configured to facilitate such a centralized healthcare facility workflow and, as noted above with respect to FIG. 2, an administrative service computing device 200 may implement a healthcare facility workflow engine 202, an operating system 204, and/or any other software or hardware component configured to operate and/or otherwise facilitate such a healthcare facility workflow. In some examples, the user computing device 300 of FIG. 3 may access a website or other interface of the healthcare facility workflow via a browser. In other examples, the user computing device 300 may include a healthcare facility workflow application 302 usable to interact with the workflow engine 202 of the administrative service computing device 200, an operating system 304, and/or any other software or hardware component configured to enable a user 108 of the device 300 to participate in such a healthcare facility workflow.

User computing device 300 can include or be connected to a user interface 306, which can be similar to or the same as user interface 124. The user interface 306 can include various types of output devices and/or input devices described above with reference to user interface 124. The user interface 306 can also include one or more input/output (I/O) interfaces to allow user computing device 300 to communicate with input, output, or I/O devices. Examples of such devices can include components of user interface 306 such as user-operable input devices and output devices described above with reference to user interface 124.

The user computing device 300 can include one or more processing unit(s) 308, which can be similar to or the same as processing unit(s) 114. Processing units 308 can be operably coupled to the I/O interface and/or other user interface(s) 306, as well as to at least one computer-readable media 310, discussed below. Processing unit(s) 308 can include, e.g., processing unit types described above such as CPU- or GPGPU-type processing unit(s). In some examples, processing unit(s) 308 can include or be connected to a memory 312, e.g., a RAM or cache.

In some examples, computer-readable media 310 of the user computing device 300 can be similar to or the same as computer-readable media 116, and can store a plurality of modules of the workflow application 302. The computer-readable media 310 can also store the operating system 304, and the operating system 304 may be similar in function and operation to the operating system 204 described above with respect to computing device 200. Processing unit(s) 308 can be configured to execute modules of the plurality of modules of the healthcare facility workflow application 302. For example, computer-executable instructions and/or other computer program instructions 314 stored within a data store 316 of the computer-readable media 310 can upon execution configure a computer such as a user computing device 300 to perform operations described herein with reference to the modules of the computer-readable media 310. The modules stored in the computer-readable media 310 can include instructions that, when executed by the one or more processing units 308, cause the one or more processing units 308 to perform operations described below.

In some examples, the data store 316 can include data storage, structured or unstructured, such as a database (e.g., a Structured Query Language, SQL, or NoSQL database) or data warehouse. In some examples, data store 316 can include a corpus or a relational database with one or more tables, arrays, indices, stored procedures, and so forth to enable data access. Data store 316 can store data for the operations of processes, applications, components, or modules stored in computer-readable media 310 or computer instructions in those modules executed by processing unit(s) 308. In some examples, the computer program instructions 314 stored in the data store 316 may comprise instructions corresponding to processes described herein or to other software executable by processing unit(s) 308.

The user computing device 300 can also include a communications interface 318, which can be similar to or the same as communications interface 122. For example, communications interface 318 can include a transceiver device such as a network interface controller (NIC) to send and receive communications over the network 110 (shown in phantom), e.g., as discussed above. As such, the user computing device 300 can have network capabilities. For example, the user computing device 300 can exchange data with computing devices 102, 104 via one or more network(s) 110, and in some examples, the user computing device 300 can receive data from one or more data source(s) (not shown) via one or more network(s) 110.

In some examples, the processing unit(s) 308 can access the module(s) on the computer-readable media 310 via a bus 320, which can be similar to or the same as bus 118. User interface 306 and communications interface 318 can also communicate with processing unit(s) 308 via bus 320. The modules of the workflow application 302 stored on computer-readable media 310 can include one or more modules (e.g., shell modules, or API modules) which are illustrated as a dashboard module 322, an inventory module 324, and a billing module 326. In the workflow application 302, the number of modules can vary higher or lower, and modules of various types can be used in various combinations. For example, functionality described associated with the illustrated modules can be combined to be performed by a fewer number of modules or APIs or can be split and performed by a larger number of modules or APIs.

Example functionality associated with the modules of the workflow application 302 will be described in greater detail below with respect to example healthcare facility workflows. However, in some example systems of the present disclosure, such as systems including a user computing device 300 configured for use in a workflow facilitated by one or more central servers or other central computing device(s) 102, the dashboard module 322 may be configured to provide one or more preference cards 128 or other user interfaces associated with the healthcare facility workflow to the user 108 of the user computing device 300 during the healthcare facility workflow. For example, the dashboard module 322 may receive one or more such preference cards 128 from the communication module 222 and/or the dashboard module 226 of the computing device 200, via the network 110. Such preference cards 128 may be executed by the dashboard module 322, and as a result (e.g., in response), the various user interfaces associated with the preference cards illustrated in FIGS. 1, 4, and 5B-5D may be rendered and/or otherwise displayed via one or more of the displays or other user interfaces 306 described above. Such preference cards 128 may provide any of the workflow information 136 described herein, as well as any of the related functionality associated therewith. The dashboard module 322 may also receive any touch inputs or other inputs received via the interface of the preference card 128 displayed on the user interface 306, and may provide such input to, for example, the communication module 222 and/or other components of the computing device 200, via the network 110. In example embodiments, the dashboard module 322 may perform any of the functions described above with respect to the dashboard module 226, and in such examples, the dashboard module 322 may be substantially similar to or the same as the dashboard module 226.

The inventory module 324 and/or the billing module 326 may function similar to the dashboard module 322 in that these modules may also receive any touch inputs or other inputs received via the interface of the preference card 128 displayed on the user interface 306 (e.g., via any of the controls included in the interface of the preference card 128), and may provide such input to, for example, the communication module 222 and/or other components of the computing device 200, via the network 110. In example embodiments, the inventory module 324 may receive inputs via the one or more controls included in the interface of the preference card 128 and may provide such input to, for example, the inventory module 230 via the network 110. Likewise, billing module 326 may receive inputs via one or more controls included in the interface of the preference card 128 and/or from the inventory module 324. The billing module 326 may provide such input to, for example, the billing module 234 via the network 110. It is understood that the inventory module 324 may perform any of the functions described above with respect to the inventory module 230, and in such examples, the inventory module 324 may be substantially similar to or the same as the inventory module 230. It is also understood that the billing module 326 may perform any of the functions described above with respect to the billing module 234, and in such examples, the billing module 326 may be substantially similar to or the same as the billing module 234.

As noted above, the example environment 100 of FIG. 1 may comprise a system for use in a centralized healthcare facility workflow. In such a centralized healthcare facility workflow, one or more computing devices 102, 200 operate and/or otherwise facilitate the healthcare facility workflow between one or more users 108, and such users 108 may be physically located at various different locations within the healthcare facility, such as locations remote from the central computing device 102, 200. In additional example embodiments, on the other hand, a decentralized or “peer-to-peer” environment may facilitate a healthcare facility workflow. In such a decentralized healthcare facility workflow, the one or more computing devices 102, 200 described above with respect to FIGS. 1 and 2 may be omitted. Instead, one or more computing devices 104, 300 may operate and/or otherwise facilitate a healthcare facility workflow between two or more users 108 according to various examples described herein. In such examples, each of the computing devices 104, 300 may implement a healthcare facility workflow application, an operating system, any of the communication, encryption, dashboard, inventory, billing, compression, and/or other modules described herein, as well as any software or hardware component configured to enable a user 108 to participate in such a decentralized healthcare facility workflow. For ease of description, however, the example centralized environment 100 of FIG. 100 and/or the corresponding computing devices 200, 300 will be referred to for the duration of this disclosure unless otherwise noted.

### Illustrative Workflow

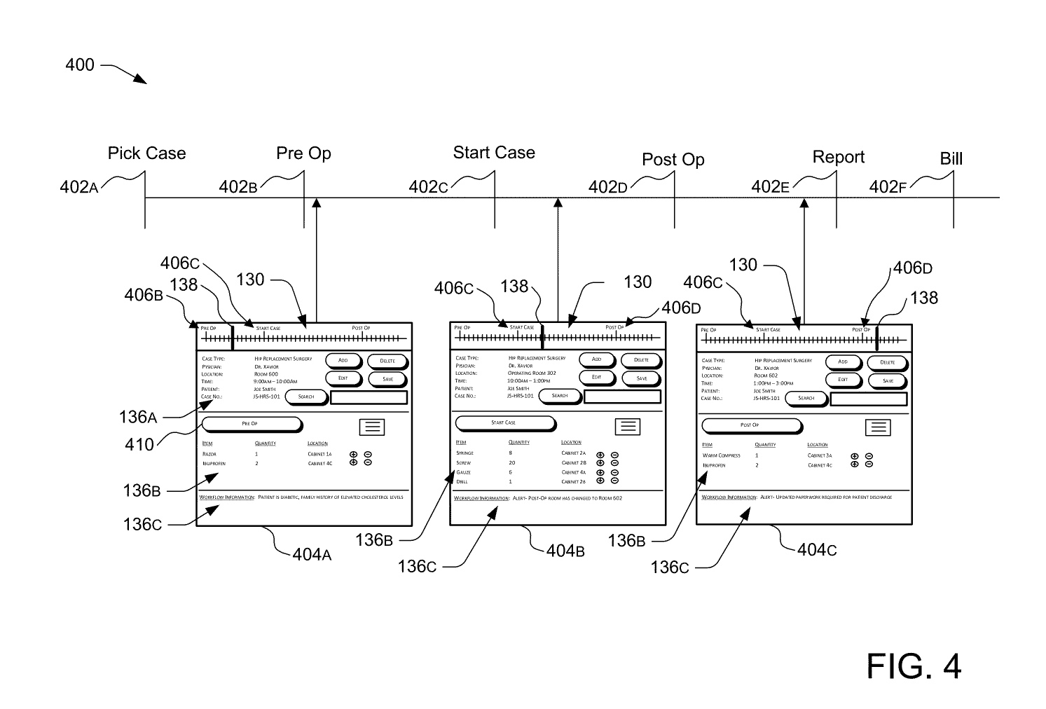

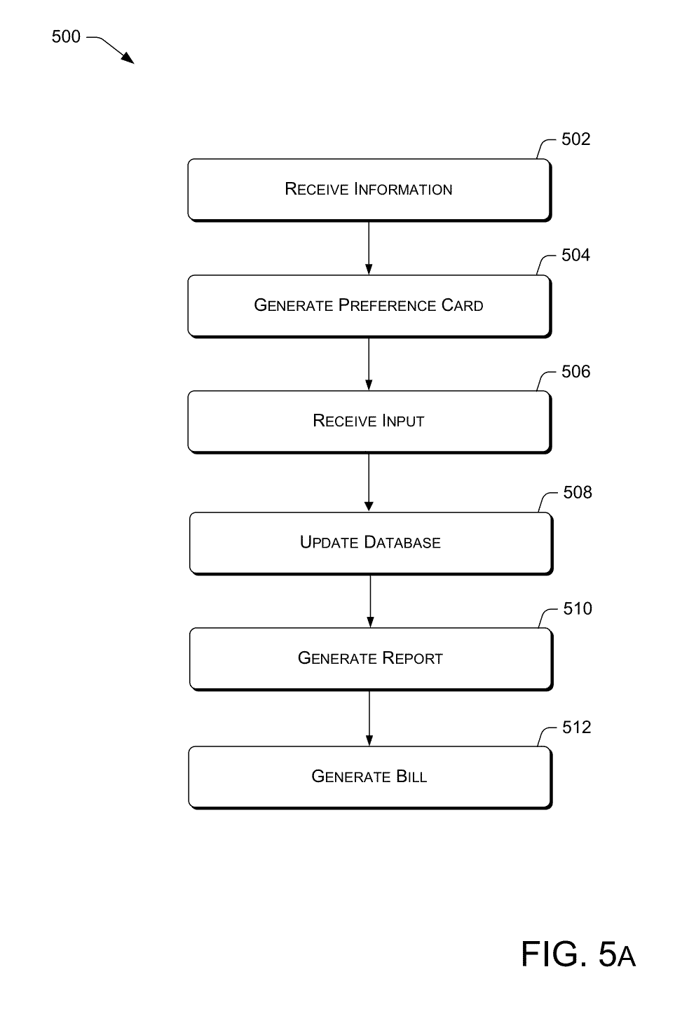

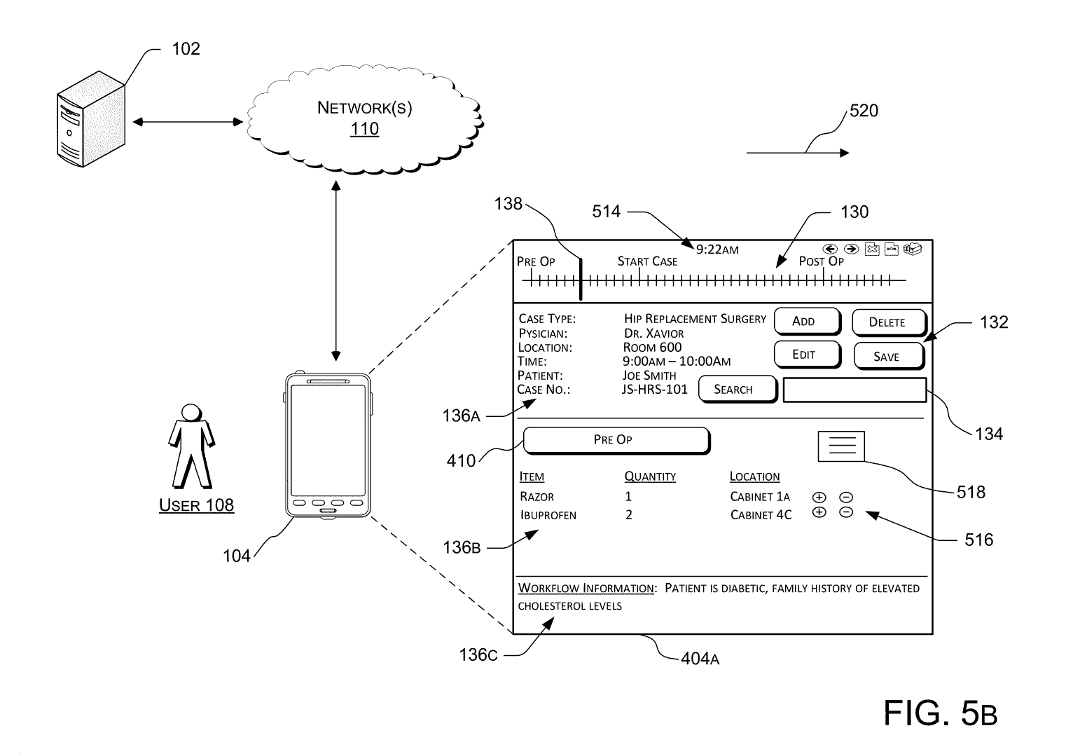

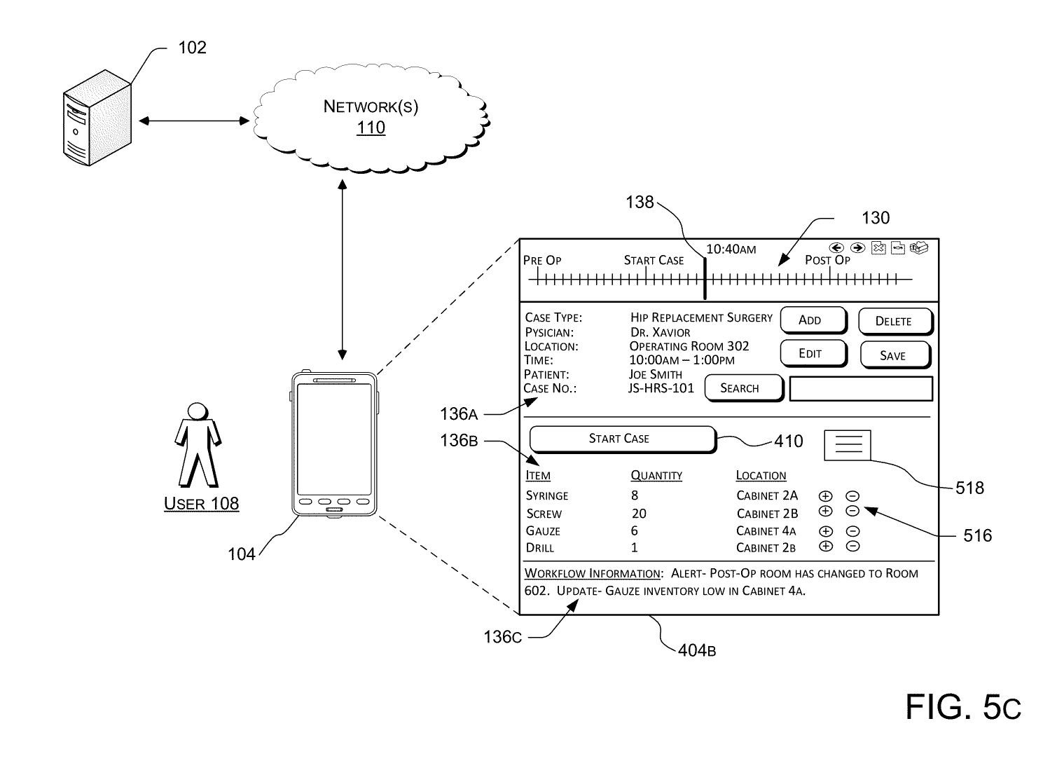

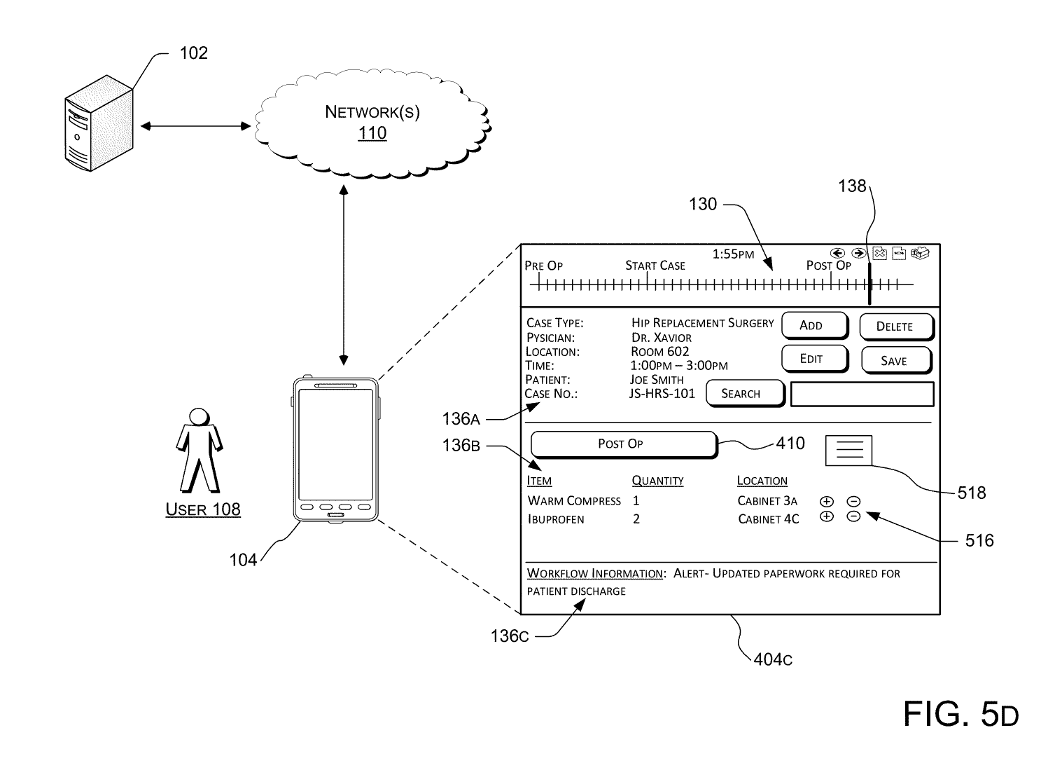

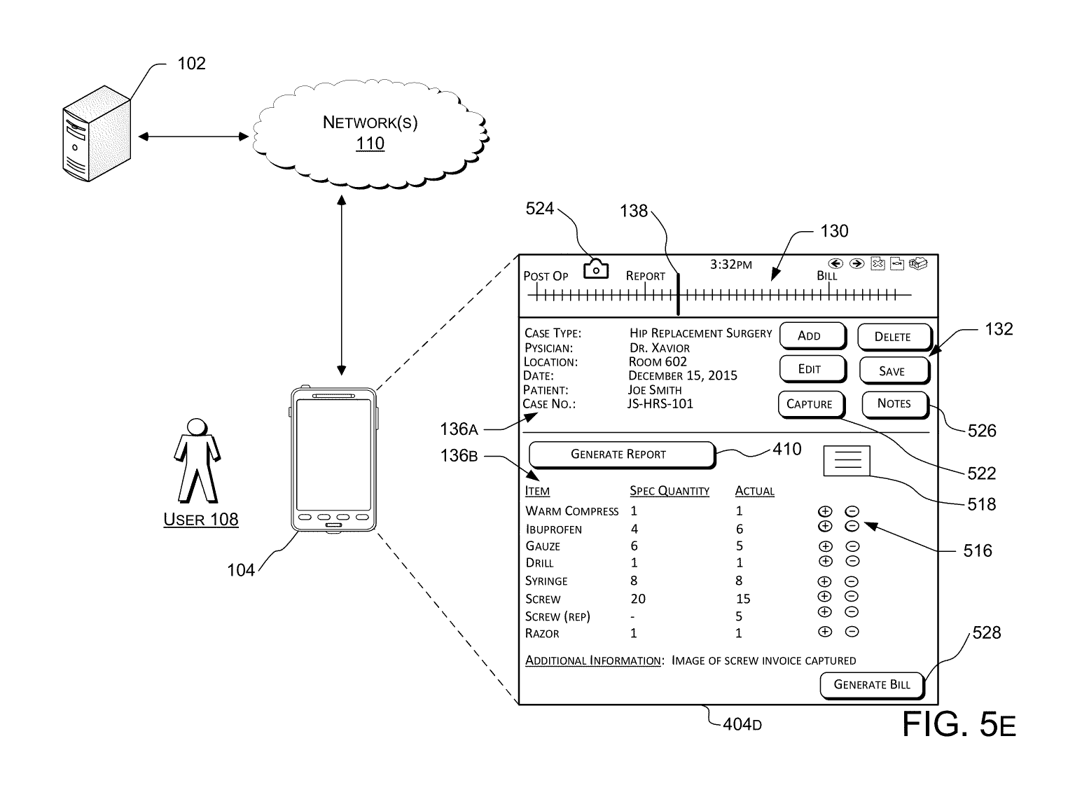

FIG. 4 is a graphical illustration of an example healthcare facility workflow 400 of the present disclosure. For example, the healthcare facility workflow 400 shown in FIG. 4 includes a plurality of consecutive segments spaced along a substantially linear timeline. Each segment of the example healthcare facility workflow 400 corresponds to an actual file, and/or case of a patient receiving a surface within a healthcare facility. For ease of explanation, the various methods, workflows, and/or other processes discussed herein with respect to FIGS. 4-5E shall be described with respect to an example workflow associated with a patient, Joe Smith, receiving a hip replacement surgery. It is understood, however, that the various methods, workflows, and/or other processes described herein are not limited to a hip replacement surgery case, and that the methods, processes, and/or healthcare facility workflows described herein shall be applicable to any other type of surgery, or other service provided by a healthcare facility.

The example healthcare facility workflow 400 of FIG. 4 includes consecutive pick case, pre op, start case, pre op, report, and bill segments. Further, the workflow 400 includes a plurality of milestones 402A, 402B . . . 402F (collectively “milestones 402”), and at least one of the milestones 402 at least partly defines at least one of the segments described above. For example, the milestones 402 illustrated in the healthcare facility workflow 400 may divide the workflow 400 into a plurality of consecutive, temporally sequential, and/or adjacent segments, and each of the respective segments may extend temporarily between a first milestone (e.g., 402A) and a second milestone (e.g., 402B) adjacent to the first milestone. For example, the pick case segment of the workflow 400 may extend from a point in time designated by the milestone 402A to the point in time designated by the milestone 402B. In this way, the healthcare facility workflow 400 may identify and/or specify various activities and/or tasks that are to be performed sequentially at different respective times.

As shown in FIG. 4, the various segments, milestones, and/or other aspects of the healthcare facility workflow 400 can also be represented in respective preference cards 404A, 404B, 404C (collectively “preference cards 404”) of the present disclosure. It is understood that any of the preference cards 128, 404 described herein may comprise one or more executable files which, when executed by one or more modules of the computing devices 104, may generate a user interface including the various controls, timelines, workflow information, and/or other content illustrated in FIGS. 1, 4, and 5B-5D of the present disclosure. Accordingly, it is understood that in any of the examples described herein, input received by a preference card, information or other content displayed by a preference card, and/or controls included in and/or provided by a preference card may be received, displayed, included in, and/or provided by the user interface corresponding to the particular preference card being executed.

For example, the preference cards 404 may each include a timeline 130, and each timeline 130 may include one or more of the segments described above. The timeline 130 may also include milestones 406B, 406C, 406D (collectively “milestones 406”) corresponding to the milestones, 402 described above. For example, each timeline 130 may include a plurality of milestones 406, and at least one of the milestones 406 may at least partly define at least one segment of the plurality of segments corresponding to the healthcare facility workflow 400. As described above, the timeline 130 may also include an indicator 138 identifying the real-time progress of the physician as the physician performs various tasks during the respective segment of the workflow 400. For example, as progress is made and/or as the physician advances from the first segment of the workflow 402 to the next segment of the workflow, the indicator 138 may move and/or otherwise transition along the timeline 130 to indicate the progress being made in real time. Accordingly, a user viewing the timeline 130 may be able to quickly understand the current status of, for example, a patient during the workflow 400. In addition to the indicator 138, each preference card 404 may also include at least one additional indicator 410 identifying the current segment of the workflow 400 being performed. It is understood that the segment identified by the indicator 410 may correspond to the segment within which the indicator 138 is disposed along the timeline 130.

It is also understood that the workflow information 136 provided by the respective preference cards 404 may be interactive, may change in real time as progress is made during a respective segment, and may also correspond to the respective segment identified by the indicator 138 and/or the indicator 410. For example, as shown with respect to the workflow information 136A of preference card 404A, in the example healthcare facility workflow 400 the patient Joe Smith may be scheduled to receive pre op segment services in room number 600 between 9:00 AM and 10:00 AM. Further, as shown with respect to workflow information 136B of preference card 404A, such pre op services may require utilization of one razor (currently located in cabinet 1A) and two doses of ibuprofen (currently located in cabinet 4C). Further, as shown with respect to workflow information 136C of the preference card 404A, Mr. Smith is diabetic and has a family history of elevated cholesterol levels.

While the above workflow information 136 may be relevant to the pre op segment of the workflow 400, once progress is made in the workflow 400 such that the patient, and/or the physician progresses to the start case segment of the workflow, a preference card 404B may be provided to the physician, and the preference card 404B may include different workflow information 136 than the preference card 404A described above. For example, the preference card 404B may indicate that during the start case segment of the workflow 400, the patient may be located in operating room 302 for the hip replacement surgery between 10:00 AM and 1:00 PM. The workflow information 136B may also indicate that eight syringes, twenty screws, six packages of gauze, and one drill are required during the start case segment of the workflow, and the workflow information 136C may provide a time-sensitive alert indicating that the post op room has changed to room 602. Thus, the preference cards 404 described herein may combine real-time inventory information, location information, and/or temporal information (e.g., timeline 130). In a single interactive user interface.

### Illustrative Methods

FIG. 5A shows a flowchart illustrating an example method 500 of the present disclosure. The example healthcare facility workflow associated with the method 500 may comprise either a centralized healthcare facility workflow or a decentralized healthcare facility workflow. Accordingly, the healthcare facility workflow associated with the method 500 may be performed, at least in part, using either the system illustrated in FIG. 1, and/or one or more components thereof, or a corresponding decentralized (e.g., peer-to-peer) system. In particular, the example functions shown in FIG. 5A and other example processes herein can be implemented on or otherwise embodied in any of the one or more computing device(s) 102, 104, 200, or 300 described herein. In a centralized workflow, one or more of the functions of method 500 may be performed by one or more of the computing devices 102, 104, 200, 300. Alternatively, in a decentralized healthcare facility workflow, one or more of the functions of method 500 may be performed by one or more of the computing devices 104, 300, and the computing devices 102, 200 may be omitted. For ease of description, example centralized healthcare facility workflows will be described for the duration of the present disclosure unless otherwise noted.

The order in which the operations are described in the example flowcharts or methods included herein is not intended to be construed as a limitation, and any number of the described operations can be combined in any order and/or in parallel to implement each method. Moreover, the operations in each of FIGS. 5A-5E can be implemented in hardware, software, and/or a combination thereof. In the context of software, the operations represent computer-executable instructions that, when executed by one or more processors, cause one or more processors to perform the recited operations. In the context of hardware, the operations represent logic functions implemented in circuitry, e.g., datapath-control and finite-state-machine sequencing functions.

In some examples, at block 502 the computing device 102 may receive information from one or more different sources. For example, during an on-boarding, scheduling, and/or other initial or preliminary segment of a workflow, a user 108 may provide information, including one or more preferences of a particular physician with respect to different procedures to be performed during the workflow. Such preferences may include, for example, the items preferred by the physician for use during each segment of the workflow, the particular brand, type, and/or other attribute of each of the particular items preferred by the physician, the quantity of each item that the physician typically uses during each segment of the workflow, and/or any additional notes or information from the physician regarding preferred methods of preparing the patient, and/or any of the workflow information 136 described herein. Such information be received by typing, scanning, and/or other means, and such information may be stored within, for example, the computer-readable media 116 of the computing device 102. Such information may be received at block 502 prior to, for example, additional segments of the workflow.

At block 504, the computing device 102 may generate one or more preference cards 128, 404 of the present disclosure. For example, during a pre op segment of the workflow, the computing device 102 may generate a preference card 404A including a timeline 130 illustrating a plurality of respective sequential segments of the workflow, a list of inventory items associated with at least one of segments, and one or more controls operable to receive input associated with at least one of the items included in the list of inventory items. For example, when the preference card 404A is executed by the computing device 104, the preference card 404A may cause the computing device 104 to display a user interface, such as via a display of the computing device 104, that includes the above content and/or other items. The preference card 404A may also include additional workflow information 136, such as, for example, the location at which the services associated with the present segment of the workflow are to be performed, the quantity of each item in the list of inventory items to be used during the current segment of the workflow, and/or any of the other workflow information 136 described above. For example, when the preference card 404A is executed by the computing device 104, the preference card 404A may cause the computing device 104 to display a user interface, such as via a display of the computing device 104, that includes the above workflow information 136. Further, the timeline may include an indicator 138 identifying, in real time, the physician's progress associated with the current respective segment of the workflow. At block 504, the computing device 102 may store one or more such preference cards 128, 404 within the preference card database 228 of the data store 216. Additionally, the computing device 102 may transfer, distribute, and/or otherwise provide the one or more preference cards 128, 404 to at least one additional computing device 104 via the network 110.

At block 506, the computing device 102 may receive an input via at least one of preference cards 128, 404 generated at block 504. For example, a user 108 may provide a touch input, and/or other input via one or more of the controls 132 displayed by the computing device 104 when the preference card 128, 404 is executed. Such an input may be provided, for example, via a touch screen of the computing device 104, and/or via one or more additional peripherals or user interfaces 124 associated with the computing device 104. In such examples, a dashboard module 322 and/or other components of the computing device 104 may provide the input and/or information indicative of the input to the computing device 102 via the network 110. In such examples, the communication module 222, and/or the dashboard module 226 of the computing device 102 may receive such input at block 506.

At block 508, the computing device 102 may update a database of the computer-readable media 116, in real time, at least partly in response to receiving the input described above with respect to block 506. For example, during the current segment of the workflow, the physician may utilize more than or less than the quantity of inventory items specified in the preference card 128, 404. In such examples, the input received at block 506 may indicate the actual quantity of one or more items utilized during the current segment of the workflow. Additionally or alternatively, the physician may decide to add an item to the list of inventory items included in the preference card 128, 404, remove one or more of the items included in the list of inventory items, and/or edit the list of inventory items. In such examples, the input received at block 506 may indicate any such changes made with respect to the preference card 128, 404. At block 508, the computing device 102 may update the preference card database 228, the inventory database, 232, and/or any other database associated with the computer-readable media 210.

At block 510, the computing device 102 may generate one or more reports associated with the workflow. For example, at block 510. The computing device 102 may generate a report indicating a predetermined quantity of items associated with the workflow. For example, as described above, the various preference cards 128, 404 may identify a predetermined quantity of items to be utilized during each segment of the workflow. In such examples, the report generated at block 510 may include the total number of each inventory item expected to be used by the physician during the workflow. Additionally, in some examples the report generated at block 510 may include the actual quantity of items utilize during the workflow. For example, inputs received at block 506 indicating that the physician actually utilized more than or less than the quantity of inventory items specified in the preference card 128, 404 may be utilized to determine the actual quantity of items included in the report. Additionally or alternatively, the computing device 102 may receive additional input at block 510. Such additional input may be received, for example, from the user 108 of the computing device 104, and via one or more controls of the various preference cards 128, 404. Such additional inputs may be received, for example, during a reporting segment of the workflow in which the user 108 performs an examination or count of the actual quantity of inventory items utilized during one or more segments of the workflow, and updates the preference card 128, 404 corresponding to the reporting segment with such information.

At block 512, the computing device 102 may generate an invoice and/or other such bill associated with the workflow. For example, the billing module 234 may generate a bill comprising a total cost associated with the workflow. The total cost may be determined based on the actual quantity of items included in the report generated at block 510. Alternatively, the total cost may be determined based on one or more inputs received during the workflow indicating actual quantities of the individual items utilized in each respective segment of the workflow. Blocks 502-512 will now be described in greater detail below with respect to FIGS. 5B-5E.

FIG. 5B illustrates an example environment of the present disclosure in which an example preference card 404A associated with a hip replacement surgery workflow has been generated by the computing device 102 and provided to the computing device 104 via the network 110. As part of an example healthcare facility workflow associated with the preference card 404A, one or more physician-specific preferences, and/or patient-specific preferences may be provided to the computing device 102 prior to generation of the preference card 404A. For example, as described above with respect to block 502, such information may be provided to the computing device 102 during an initial segment of the workflow, and the computing device 102 may generate the preference card 404A during, for example, a subsequent pre op segment of the workflow based at least partly on such received information. Additionally, commensurate with receiving such information at block 502 and/or commensurate with the generation of such an example preference card 404A associated with the pre op segment (e.g., at block 504), a nurse, physician's assistant, physician, and/or other healthcare facility staff member may review the information and/or the list of inventory items included in the workflow information 136, provided by the preference card 404A. Thus, prior to and/or during the pre op segment of such a workflow, such healthcare facility staff members may physically collect the items included in, for example, the list of inventory items 136B, and may dispose the collected items at the location identified by the workflow information 136A of the preference card 404A (e.g., Room 600). The preference card 404A may also include workflow information 136B, indicating the current location of each of the inventory items required for the pre op segment of the workflow.

As shown in FIG. 5B, when the preference card 404A is executed by the computing device 104, the preference card 404A may cause the computing device 104 to display a user interface, such as via a display of the computing device 104, that includes an indication of the current date, time, and/or other real-time information 514. Such real-time information 514 may correspond to, for example, the position of the indicator 138 shown on the timeline 130. For example, the indicator 138 displayed on the timeline 130 may be representative of the real-time progress of the physician and/or the patient during one or more segments of the workflow illustrated on the timeline 130. In this way, over the course of time (as indicated by the real-time information 514), the indicator 138 may move (e.g., in real-time) in the direction of arrow 520 to indicate such progress and/or to indicate the passage of time.

When the preference card 404A is executed by the computing device 104, the preference card 404A may cause the computing device 104 to display a user interface that also includes any of the controls 132, 134 described above, and may also include one or more additional controls 516, 518 associated with the workflow information 136, and/or with the workflow, generally. For example, one or more of the controls 516 may be operable to receive input from the user 108 during the pre op segment of the workflow, and such input may be indicative of, for example, physical removal of one or more items from inventory. For example, upon removing one or more of the items included in the list of inventory items 136B shown in the user interface associate with preference card 404A, the user 108 may indicate such physical removal by providing an input, via one or more of the controls 516. Such input may be received by the computing device 104 and may be transferred to the computing device 102 via the network 110. For example, the dashboard module 322 of the computing device 104 may transfer information indicative of the input to the inventory module 230 of the computing device 102. Such input may be received by, for example, the inventory module 230 at block 506. Additionally, at block 508, the inventory module 230 may update the inventory database, 232 in response to and/or based at least partly on such an input. Additionally, one or more of the controls 518 may provide additional functionality to the user 108 such as, for example, enabling the user 108 to indicate completion of one or more tasks associated with the respective segment (e.g., pre op) of the workflow to which the preference card 404A corresponds. Such controls 518 may also enable the user 108 to, for example, enter notes and/or other information into the preference card 404A, and/or provide one or more alerts and/or notices associated with the inventory, the workflow, and/or the respective segment of the workflow.

FIG. 5C illustrates an example environment of the present disclosure in which another example preference card 404B associated with a hip replacement surgery workflow has been generated by the computing device 102 and provided to the computing device 104 via the network 110. As shown in FIG. 5C, when the preference card 404B is executed by the computing device 104, the preference card 404B may cause the computing device 104 to display a user interface, such as via a display of the computing device 104, that includes the indicators 138, 410. In the present example, the indicators 138, 410 indicate the physician and/or the patient is currently in the “start case” segment of the workflow. In the example shown in FIG. 5C, the start case segment may comprise a hip replacement surgery taking place in operating room 302 between 10:00 AM and 1:00 PM. In particular, as shown in the user interface corresponding to preference card 404B, the indicator 138 may be located within the start case segment of the workflow illustrated in the timeline 130. The start case segment of the workflow may be sequentially subsequent to the pre op segment described above with respect to FIG. 5B.

Additionally, the workflow information 136 displayed in the user interface corresponding to preference card 404B may correspond to the current segment (e.g., the start case segment) of the workflow. For example, the workflow information 136A may identify the physician, location, time, patient, and/or other information associated with the hip replacement surgery that is currently underway. Moreover, the workflow information 136B may include a list of inventory items required in order to perform the current hip replacement surgery, a particular (e.g., predetermined) quantity of each inventory item that is required, and/or preferred by the physician performing the surgery, and the current location of each item included in the list of inventory items. Additionally, the workflow information 136C may provide one or more time-sensitive alerts, inventory information, patient information, and/or other information to the user, 108, that may be relevant to the present segment of the workflow, and/or to one or more previous or upcoming segments of the workflow. It is understood that when the preference card 404B is executed by the computing device 104, the preference card 404B may cause the computing device 104 to display a user interface that includes one or more of the controls 132, 134, 516, 518 described above. Accordingly, in any of the workflow segments described herein, one or more of the preference cards 404 corresponding to such workflow segments may enable the user 108 to provide information regarding the actual quantity of inventory items used during the respective workflow segment and/or to add, delete, edit, save, search for, and/or otherwise modify any of the information associated with the respective preference card 404. Any of the input and/or other information provided via the one or more controls, 132, 134, 516, 518, may be saved locally in the computer-readable media 310 of the computing device 104 and/or may be provided to the computing device 102 via the network 110.

FIG. 5D illustrates an example environment of the present disclosure in which a further example preference card 404C associated with a hip replacement surgery workflow has been generated by the computing device 102 and provided to the computing device 104 via the network 110. As shown in FIG. 5D, when the preference card 404C is executed by the computing device 104, the preference card 404C may cause the computing device 104 to display a user interface, such as via a display of the computing device 104, that includes the indicators 138, 410. Based on the indicators 138, 410 shown in FIG. 5D, the physician and/or the patient may now be in the post op segment of the workflow, which, in this example, may be taking place in room 602 of the healthcare facility between 1:00 PM and 3:00 PM. In particular, as shown in the user interface corresponding to preference card 404C, the indicator 138 may be located within the post op segment of the workflow illustrated in the timeline 130. The post op segment of the workflow may be sequentially subsequent to the start case segment described above with respect to FIG. 5C. Additionally, the workflow information 136 displayed in the user interface corresponding to preference card 404C may correspond to the current segment (e.g., the post op segment) of the workflow. For example, the workflow information 136A may identify the physician, location, time, patient, and/or other information associated with the post op procedures that are currently underway. Moreover, the workflow information 136B may include a list of inventory items required in order to perform the current post op procedures, a particular (e.g., predetermined) quantity of each inventory item that is required, and/or preferred by the physician, nurse, physician's assistant and/or other healthcare facility staff member performing the post op procedure, and the current location of each item included in the list of inventory items. Additionally, the workflow information 136C may provide one or more time-sensitive alerts, inventory information, patient information, and/or other information to the user 108 that may be relevant to the present segment of the workflow, and/or to one or more previous or upcoming segments of the workflow. It is understood that the user interface associated with the preference card 404C may also include one or more of the controls 132, 134, 516, 518 described above.

FIG. 5E illustrates an example environment of the present disclosure in which another example preference card 404D associated with a hip replacement surgery workflow has been generated by the computing device 102 and provided to the computing device 104 via the network 110. As shown in FIG. 5E, when the preference card 404D is executed by the computing device 104, the preference card 404D may cause the computing device 104 to display a user interface, such as via a display of the computing device 104, that includes the indicators 138, 410. In the example shown in FIG. 5E, the indicators 138, 410 indicate that the physician and/or the patient is currently in the report segment of the workflow. In particular, as shown in the user interface corresponding to preference card 404D, the indicator 138 may be located within the report segment of the workflow illustrated in the timeline 130. The report segment of the workflow may be sequentially subsequent to the post op segment described above with respect to FIG. 5D, and one or more of the processes enabled by the preference card 404D may be performed at block 510 (FIG. 5A). Additionally, at least some of the workflow information 136 displayed in the user interface corresponding to the preference card 404D may correspond to the current segment (e.g., the report segment) of the workflow. For example, the workflow information 136B may include a complete list of inventory items required to perform the procedures included in each segment of the workflow. The inventory list may also include the particular (e.g., predetermined) quantity of each inventory item that is required, and/or preferred by the physician, nurse, physician's assistant and/or other healthcare facility staff member performing such procedure. The inventory list may also include the actual quantity of items used during the various segments of the workflow. Further, while some of the above examples describe inventory items and/or various procedures associated with segments of a workflow, in further examples, the items, tasks, and/or workflow information 136 provided by the preference card may include non-procedural information including, for example, providing food for a patient, providing medicine to a nursing home patient, and/or other information or tasks.

As noted above, the user 108 may modify the actual quantity of items represented in the user interface corresponding to the preference card 404D during the report segment of the workflow by using one or more of the controls 516, 518. For example, as shown in the user interface illustrated in FIG. 5E, a predetermined quantity (e.g., total) of ibuprofen required for the various segments of an example hip replacement surgery workflow may be four. However, during the course of the workflow two additional ibuprofen may have been used. In this example, and as shown in the user interface corresponding to preference card 404D, user 108 may provide an input via one of the controls 516 to indicate that the actual quantity of ibuprofen used during the workflow was six. Additionally, as shown in the user interface corresponding to preference card 404D, a predetermined quantity of gauze pads required for the example hip replacement surgery workflow may be six. However, during the course of the workflow, only five gauze pads may have been used. In such an example, the user 108 may provide an input, via one or more of the controls 516 to indicate that the actual quantity of gauze pads used during the workflow was five.

As shown in FIG. 5E, when the preference card 404D is executed by the computing device 104, the preference card 404D may cause the computing device 104 to display a user interface that includes one or more additional controls configured to provide enhanced functionality to the user 108. For example, the user interface corresponding to preference card 404D may include a capture control 522 configured operate one or more image capture tools 524 of the preference card 404D. For example, such image capture tools 524 may cooperate and/or may operate in conjunction with the one or more cameras and/or other image sensors of the computing device 104 in order to facilitate capturing an image of an invoice, a receipt, and/or other item associated with the workflow.

In an example embodiment, the user 108 may provide an input via the capture control 522. Such an input may activate the image capture tool 524 and/or may otherwise enable the user 108 to capture an image. Such functionality may be useful in situations where, for example, one or more items utilized during the workflow is obtained from a vendor, representative, and/or other third-party. In such examples, one or more receipts corresponding to the item may be required for reimbursement purposes. Such an example situation is represented by the user interface corresponding to preference card 404D. For instance, as shown in FIG. 5E, a predetermined quantity of screws required for the example hip replacement surgery workflow may be 20. However, during the course of the workflow, only 15 screws from inventory may have been used. The remaining five screws may have been obtained from a third party vendor and/or representative during one of the segments of the workflow. In such an example, the user 108 may provide an input, via one or more of the controls 132, 516 to indicate the sources and quantities of the screws used during the workflow. The user 108 may also utilize the capture control 522, and/or the tool 524 to capture an image of a receipt provided by the third-party representative corresponding to the remaining five screws obtained therefrom. The user 108 may also utilize a notes control 526 to provide additional information regarding, for example, the source of the remaining five screws, an indication that an invoice for the remaining screws has been captured, and/or any other information relevant to the report segment of the workflow. Once captured, the image of the receipt. Maybe saved within the computer-readable media 310 of the computing device 104. Additionally, and/or, alternatively, the image may be provided to the computing device 102 via the network 110 for storage in the computer readable media 210.

When the preference card 404D is executed by the computing device 104, the preference card 404D may cause the computing device 104 to display a user interface that also includes one or more controls 528 configured to enable one or more of the computing devices 102, 104 to generate a report (e.g., such as at block 510) and/or to generate a bill (e.g., such as at block 512). For example, user 108 may provide an input via the control 528, and in response, the computing device 104 may send one or more signals to the computing device 102, via the network 110, instructing the inventory module 230 and/or the billing module 234 to generate one or more of the reports described herein. In such embodiments, the user 108 may also provide an input via the control 528 and, in response, the computing device 104 may send one or more signals to the computing device 102, via the network 110, instructing the inventory module 230 and/or the billing module 234 to generate one or more bills associated with the workflow. As noted above, such bills may include a total cost for the workflow, and such a total cost may be determined based on, among other things, the actual quantity of items used during the workflow, as identified by the user, 108. Additionally, the various images captured using the capture control 522 may be incorporated into one or more of the reports and/or one or more of the bills described herein. As noted above, incorporating such a digital image into the report and/or the bill generated by the computing device 102 may include generating an electronic file (e.g., an electronic bill file and/or an electronic report file), and merging the digital image with the generated electronic file. Merging and/or otherwise combining the digital image with the generated electronic file may augment the generated electronic file.

### CONCLUSION

Various systems, environments, and/or methods described herein can facilitate centralized or decentralized healthcare facility workflows. Although the techniques have been described in language specific to structural features or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more computing device(s) 102, 104, or 200 such as one or more internal or external CPUs or GPUs, and/or one or more pieces of hardware logic such as FPGAs, DSPs, or other types described above.

Conditional language such as, among others, “can,” “could,” “might” or “may,” unless specifically stated otherwise, mean that certain examples include, while other examples do not include, certain features, elements and/or operations. Thus, such conditional language is meant to indicate that certain features, elements and/or operations are permissible but not required for one or more examples. Conjunctive language such as the phrase “at least one of X, Y or Z” and “and/or,” unless specifically stated otherwise, is to be understood to present that an item, term, etc., can be either X, Y, or Z, or a combination thereof

Any descriptions, elements or blocks in the flow diagrams described herein and/or depicted in the attached figures should be understood as representing modules, segments, or portions of code that include one or more executable instructions for implementing specific logical functions or elements. Many variations and modifications can be made to the above-described examples. All such modifications and variations are intended to be included herein within the scope of this disclosure and protected by the following claims. For instance, the examples described herein include variations in which elements or functions are deleted, or executed out of order from that shown or discussed, including substantially synchronously or in reverse order, depending on the functionality involved as would be understood by those skilled in the art.

What is claimed is:

1. A system, comprising:
one or more processing units; and
computer-readable media operably connected to the one or more processing units, the computer-readable media storing a plurality of modules that, when executed by the one or more processing units, cause the one or more processing units to perform operations comprising:
generating, by a dashboard module, a preference card associated with a healthcare facility workflow, wherein when executed, the preference card causes a computing device to provide an interface including:
a timeline illustrating at least one segment of a plurality of sequential segments of the workflow,
an indicator identifying progress in the at least one segment,
a list of inventory items associated with the at least one segment, and
a control operable to receive input associated with at least one item of the list of inventory items;
receiving, by the control, an input associated with the at least one item;
updating, by an inventory module and in real time, a database at least partly in response to receiving the input; and
generating, by the inventory module, a report associated with the workflow, the report indicating a predetermined quantity of items associated with the workflow and an actual quantity of items used during the workflow, wherein the actual quantity is based at least partly on the input.

2. The system of claim 1, wherein the input comprises a touch input, and the control comprises at least one of an add button operable to enable an additional item to be added to the list of inventory items and an edit button operable to enable modification of information associated with the at least one item.

3. The system of claim 1, wherein the timeline includes a plurality of milestones, at least one milestone of the plurality of milestones at least partly defining the at least one segment, and the indicator identifying progress in the at least one segment in real time.

4. The system of claim 1, wherein the list of inventory items indicates a quantity of each item of the list of inventory items required for the at least one segment, and a real-time location of each item of the list of inventory items.

5. The system of claim 1, wherein the interface further includes workflow information comprising at least one of a time-sensitive alert, a real-time inventory update, and information associated with a patient receiving services during the workflow.

6. The system of claim 1, wherein, when executed, the communication module performs further operations, comprising providing the preference card, via a network, to a computing device.

7. The system of claim 1, the operations further comprising, by a billing module, generating a bill based at least partly on the report, the bill comprising a total cost determined based on the actual quantity of items included in the report.

8. The system of claim 7, wherein, when executed, at least one of the billing module and the inventory module performs further operations, comprising incorporating a captured image of a receipt associated with an item identified in the report into at least one of the report and the bill.

9. The system of claim 1, wherein, when executed, the communications module performs further operations, comprising receiving information during a segment of the plurality of segments prior to the at least one segment.

10. The system of claim 9, the operations further comprising, by an encryption module, generating an encryption key corresponding to the received information, and associating the encryption key with the received information such that an electronic transfer of the received information includes a corresponding electronic transfer of the encryption key.

11. The system of claim 9, the operations further comprising, by a compression module, generating modified information by compressing at least a portion of the received information, and storing the modified information within the computer-readable media.

12. A method, comprising:
generating a first preference card associated with a healthcare facility workflow, wherein when executed, the preference card causes a computing device to provide a first interface including:
a timeline illustrating a first segment of a plurality of sequential segments of the workflow,
a first list of inventory items associated with the first segment, and
a first control operable to receive input associated with at least one item of the first list of inventory items;
generating a second preference card associated with the workflow different from the first preference card, wherein when executed, the second preference card causes the computing device to provide a second interface including:
a timeline illustrating a second segment of the plurality of sequential segments adjacent to the first segment,
a second list of inventory items associated with the second segment, and
a second control operable to receive input associated with at least one item of the second list of inventory items;
receiving an input by at least one of the first control and the second control; and
updating a database, in real time, at least partly in response to receiving the input.

13. The method of claim 12, further comprising generating an indicator associated with at least one of the timeline illustrating the first segment and the timeline illustrating the second segment, the indicator identifying progress with respect to at least one of the first segment and the second segment.

14. The method of claim 12, wherein the second preference card is generated at least partly in response to completion of the first segment.

15. The method of claim 12, wherein the input indicates an actual quantity of an item used during the workflow, the method further including generating a bill comprising a total cost determined based at least partly on the actual quantity of the item.

16. The method of claim 15, further comprising capturing an image of a receipt and incorporating the image into the bill.

17. The method of claim 12, wherein the first list indicates a quantity of the at least one item of the first list required for the first segment, and a real-time location of the at least one item of the first list.

18. A method, comprising:
generating a preference card associated with a healthcare facility workflow, wherein when executed, the preference card causes a computing device to provide an interface including:
a timeline illustrating at least one segment of a plurality of sequential segments of the workflow,
a list of inventory items associated with the at least one segment,
a predetermined quantity of each item of the list of inventory items required for the at least one segment, and
a control operable to receive input associated with at least one item of the list of inventory items;
providing the preference card, via a network, to the computing device;
receiving an input, via the network, from the computing device, the input indicating a change in information provided by the interface;
updating a database, in real time, at least partly in response to receiving the input from the computing device; and
generating a bill comprising a total cost determined based at least partly on the input.

19. The method of claim 18, wherein the input comprises at least one of an addition of an item to the list of inventory items, a deletion of an item from the list of inventory items, a modification of workflow information provided by the interface, and an indication of an actual quantity of an item used during the at least one segment.

20. The method of claim 18, further comprising receiving, via the network, from the computing device an indication of an actual quantity of an item used during the at least one segment, and generating the bill based at least partly on the actual quantity.

21. The method of claim 18, further comprising receiving, via the network, an image of a receipt from the computing device, and incorporating the image into the bill, wherein the receipt is associated with an item used during the at least one segment and not in inventory.

22. The method of claim 15, further comprising generating at least one of a time-sensitive alert and a real-time inventory update, and providing the at least one of the time-sensitive alert and the real-time inventory update, via the network, to the computing device such that the at least one of the time-sensitive alert and the real-time inventory update is displayed in the interface.
